(19) United States
(12) Patent Application Publication
(10) Pub. No.: US 2017/0351362 A1
(43) Pub. Date: Dec. 7, 2017

(54) TOUCH PANEL

(71) Applicant: FUJIFILM Corporation, Tokyo (JP)

(72) Inventors: Katsuyuki NUKUI, Kanagawa (JP); Kensuke KATAGIRI, Kanagawa (JP); Shinya OGIKUBO, Kanagawa (JP); Toshinari FUJII, Kanagawa (JP); Shin TAJIRI, Kanagawa (JP)

(73) Assignee: FUJIFILM Corporation, Tokyo (JP)

(21) Appl. No.: 15/686,176

(22) Filed: Aug. 25, 2017

Related U.S. Application Data
(63) Continuation of application No. PCT/JP2015/078993, filed on Oct. 14, 2015.

(30) Foreign Application Priority Data
Mar. 26, 2015 (JP) 2015-065241

(51) Int. Cl. G06F 3/044

(52) U.S. Cl. CPC G06F 3/044; G06F 2203/04103

(57) ABSTRACT

The touch panel includes an image display device, an adhesive layer formed by curing an ultraviolet-curable adhesive, a touch panel sensor, and a protective substrate in this order, the touch panel sensor includes any one polymer film of a cyclic olefin polymer film and a cyclic olefin copolymer film, an ultraviolet absorption layer is provided between the polymer film and the protective substrate, a transmittance of the ultraviolet absorption layer in a wavelength range of 200 to 340 nm is 5% or less, a transmittance of the ultraviolet absorption layer at a wavelength of 400 nm is 86% or more, and a transmittance of the ultraviolet absorption layer in a wavelength range of 400 to 800 nm is in a range of ±3% or less of the transmittance at a wavelength of 400 nm.

### CROSS-REFERENCE TO RELATED APPLICATIONS

This application is a Continuation of PCT International Application No. PCT/JP2015/78993, filed on Oct. 14, 2015, which claims priority under 35 U.S.C. §119(a) to Japanese Patent Application No. 2015-065241, filed on Mar. 26, 2015. Each of the above application(s) is hereby expressly incorporated by reference, in its entirety, into the present application.

### BACKGROUND OF THE INVENTION

### 1. Field of the Invention

The present invention relates to a touch panel.

### 2. Description of the Related Art

In recent years, cyclic olefin polymer (COP) films or cyclic olefin copolymer (COC) films have been attracting attention as film substrates for optical functional materials. COP films or COC films are substrates that are highly optically transparent and highly optically isotropic (low phase differences).

Attempts are being made to apply COP films or COC films to a variety of usages, and, for example, attempts are being made to use COP films or COC films as substrates in touch panel sensors (JP2014-112510A).

In a case in which a touch panel sensor produced using a polyethylene terephthalate (PET) film as a substrate is embedded in a touch panel, and a user observes the screen of the touch panel while wearing sunglasses, rainbow-shaped interference fringes (rainbow unevenness) become visible depending on view angles, and thus the visibility of the display screen of the touch panel degrades or a disadvantage of the display screen of the touch panel becoming heavily dark and invisible (blackout) is caused. In contrast, in a case in which a touch panel sensor produced using a COP film or a COC film as a substrate is embedded in a touch panel, even in a case in which a user observes the touch panel while wearing sunglasses, rainbow unevenness or blackout is not caused, and the visibility is excellent.

### SUMMARY OF THE INVENTION

Meanwhile, recently, in the production of touch panels, studies are underway regarding the lamination of touch panel sensors on image display devices using direct bonding methods. Direct bonding methods are more preferable than air gap methods of the related art since it is possible to remove reflection components attributed to air interface in touch panels, and the transmittance of image display regions improves.

In direct bonding methods, in the case of the lamination of touch panel sensors and image display devices, ultraviolet-curable adhesives are preferably used. This is because ultraviolet-curable adhesives are relatively freely transformable in steps before irradiation with ultraviolet rays, the unifomi adhesion and attachment state between touch panel sensors and image display devices is easily obtained in the entire surfaces, and adhesion in the interfaces can be strengthened by irradiating the laminate with ultraviolet rays from the viewer side after the establishment of the above-described adhesion state.

Meanwhile, the present inventors found that, in a case in which a touch panel in which a touch panel sensor including a COP film or a COC film as the substrate is embedded is used outdoors for a long period of time and then strongly impacted, the functions of the touch sensor stop working more often. As a result of studying causes therefor, the present inventors estimated that ultraviolet rays incident during outdoor use deteriorate the COP film or the COC film, the deterioration of the brittleness of the substrate leads to the breakage of the COP film or the COC film in the case of being impacted, and conductive layers (detection electrodes or lead wires) disposed on the substrate made of the COP film or the COC film also break.

Therefore, the present inventors designed to introduce an ultraviolet absorption layer into touch panels and prevent COP films or COC films from being easily deteriorated by ultraviolet rays. However, it was found that, in a state in which ultraviolet absorption layers are not sufficiently designed and studied, there are problems in that the tone of touch panels deteriorates (tint changes attributed to ultraviolet absorption layers) or ultraviolet-curable adhesives cannot be sufficiently cured by ultraviolet rays in the production of touch panels using direct bonding methods.

As described above, it was found that, in touch panels in which touch panel sensors including COP films or COC films as substrates are embedded, in order to satisfy high drop impact durability, excellent tones, and high manufacturing suitability for direct bonding methods at the same time, additional efforts are required.

The present invention has been made in consideration of the above-described circumstances, and an object of the present invention is to provide a touch panel which exhibits high drop impact durability, excellent tones, and high manufacturing suitability for direct bonding methods and in which a touch panel sensor including a COP film or a COC film as the substrate is embedded.

As a result of intensively studying the above-described object, the present inventors found that the use of an ultraviolet absorption layer exhibiting predetermined optical characteristics provides desired effects.

That is, it was found that the following constitutions enable the object to be achieved.

(1) A touch panel comprising: an image display device; an adhesive layer formed by curing an ultraviolet-curable adhesive; a touch panel sensor; and a protective substrate in this order, in which the touch panel sensor includes any one polymer film of a cyclic olefin polymer film and a cyclic olefin copolymer film, an ultraviolet absorption layer is provided between the polymer film and the protective substrate, a transmittance of the ultraviolet absorption layer in a wavelength range of 200 to 340 nm is 5% or less, a transmittance of the ultraviolet absorption layer at a wavelength of 400 nm is 86% or more, a transmittance of the ultraviolet absorption layer in a wavelength range of 400 to 800 nm is in a range of ±3% or less of the transmittance at a wavelength of 400 nm, and the ultraviolet-curable adhesive is cured by light having a wavelength in a range of longer than 340 nm and 400 nm or shorter.

(2) The touch panel according to (1), in which the ultraviolet absorption layer is an adhesive layer having an ultraviolet absorbent.

(3) The touch panel according to (1), in which the ultraviolet absorption layer is a non-adhesive layer having an ultraviolet absorbent.

(4) The touch panel according to any one of (1) to (3), in which a thickness of the polymer film is 100 μm or less.

(5) The touch panel according to any one of (1) to (4), in which the ultraviolet absorbent includes at least one absorbent selected from the group consisting of benzotriazole-based ultraviolet absorbents and hydroxyphenyl triazine-based ultraviolet absorbents.

According to the present invention, it is possible to provide a touch panel which exhibits high drop impact durability, excellent tones, and high manufacturing suitability for direct bonding methods and in which a touch panel sensor including a COP film or a COC film as the substrate is embedded.

### BRIEF DESCRIPTION OF THE DRAWINGS

FIG. 1 is a cross-sectional view of a first embodiment of a touch panel of the present invention.

FIG. 2 is a plan view of an embodiment of an electrostatic capacitance-type touch panel sensor.

FIG. 3 is a cross-sectional view in a direction of a cutting line A-A illustrated in FIG. 2.

FIG. 4 is an enlarged plan view of a first detection electrode.

FIG. 5 is a partial cross-sectional view of another embodiment of the electrostatic capacitance-type touch panel sensor.

FIG. 6 is a partial cross-sectional view of still another embodiment of the electrostatic capacitance-type touch panel sensor.

FIG. 7 is a cross-sectional view of a second embodiment of the touch panel of the present invention.

FIG. 8 is a cross-sectional view of a third embodiment of the touch panel of the present invention.

FIG. 9 is a cross-sectional view of an electrostatic capacitance-type touch panel sensor in the third embodiment of the touch panel of the present invention.

FIG. 10 is a transmission spectrum graph of sharp cut filters used in examples.

### DESCRIPTION OF THE PREFERRED EMBODIMENTS

Hereinafter, preferred aspects of a touch panel of the present invention will be described with reference to the accompanying drawings.

Meanwhile, in the present specification, (meth)acrylic resins refer to acrylic resins and/or methacrylic resins. In addition, (meth)acrylate refers to acrylate and/or methacrylate.

Furthermore, in the present specification, numerical ranges expressed using “to” include numerical values before and after the “to” as the lower limit value and the upper limit value.

One feature of the present invention is the use of an ultraviolet absorption layer exhibiting predetemiined optical characteristics. One optical feature of the ultraviolet absorption layer is the transmittance that is set to be a predetermined value or lower in a wavelength range of 200 to 340 nm in order to impart ultraviolet durability to a COP film or a COC film disposed on the image display device side of the ultraviolet absorption layer. Although described in detail below, the present inventors carried out investigations using sharp cut filters manufactured by HOYA Corporation in order to clarify cut wavelengths that are necessary to impart ultraviolet durability to COP films or COC films and clarified that, in a case in which ultraviolet rays having wavelengths of 340 nm or shorter are cut, in touch panels including COP films or COC films as substrates (polymer films), polymer films do not easily deteriorate due to ultraviolet rays.

In addition, the present inventors further found that, in a case in which ultraviolet absorbents that absorb ultraviolet rays having wavelengths of 340 nm or shorter but slightly absorb ultraviolet rays having wavelengths of 400 nm or longer are selected and used in ultraviolet absorption layers, it is possible to maintain the neutral tones of touch panel sensors while securing the ultraviolet durability of COP films or COC films.

Furthermore, in the case of producing a touch panel sensor using a direct bonding method, in a case in which an ultraviolet-curable adhesive that cures by light having a wavelength of longer than 340 nm and 400 nm or shorter while remaining non-cured is used to attach an image display device and a laminate including a touch panel sensor (laminate including an electrostatic capacitance-type touch panel sensor, an adhesive layer, and a protective substrate), it is possible to cure the ultraviolet-curable adhesive by means of ultraviolet irradiation after the attachment, and it becomes possible to efficiently produce the touch panel using the direct bonding method.

In the above-described manner, it became possible to obtain a touch panel having high drop impact durability, excellent tones, and high manufacturing suitability for direct bonding methods by installing an ultraviolet absorption layer that absorbs ultraviolet rays having predetermined wavelengths.

### First Embodiment

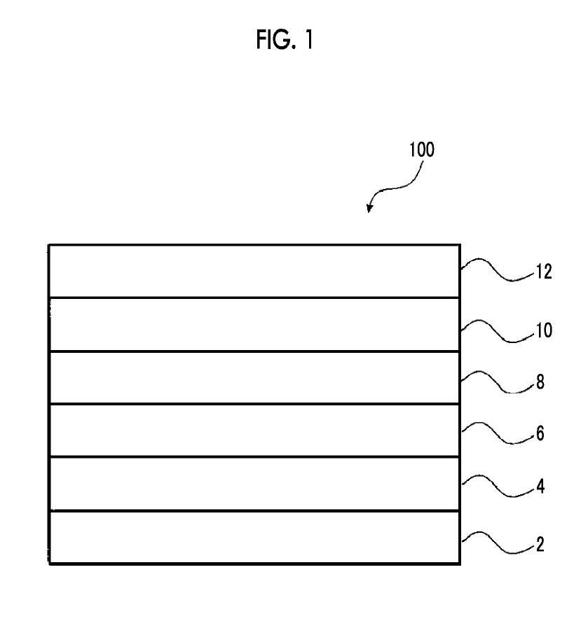

FIG. 1 is a cross-sectional view of a first embodiment of the touch panel of the present invention.

As illustrated in FIG. 1, a touch panel 100 comprises an image display device 2, an adhesive layer 4 formed by curing an ultraviolet-curable adhesive (corresponding to a lower adhesive layer), an electrostatic capacitance-type touch panel sensor 6, an ultraviolet absorption layer 8, an upper adhesive layer 10, and a protective substrate 12 in this order. The touch panel 100 is a so-called electrostatic capacitance-type touch panel, and, in a case in which a finger comes close and into contact with the surface (touch surface) of the protective substrate 12, the electrostatic capacitance between the finger and a detection electrode in the electrostatic capacitance-type touch panel sensor 6 changes. Here, a location detection driver, not illustrated, detects changes in the electrostatic capacitance between the finger and the detection electrode at all times. In the case of detecting a change in the electrostatic capacitance that is equal to or more than a predetermined value, the location detection driver detects the location in which the change in the electrostatic capacitance has been detected as an input location. In the above-described manner, the touch panel 100 is capable of detecting input locations.

Meanwhile, in the touch panel 100, the image display device 2 and the electrostatic capacitance-type touch panel sensor 6 are directly laminated together through the adhesive layer 4.

Hereinafter, the respective members in the touch panel 100 will be described in detail. Aspects of the ultraviolet absorption layer 8 which is a feature of the present invention will be described in detail, and then other members will be described in detail.

(Ultraviolet Absorption Layer)

The ultraviolet absorption layer 8 is a layer that is disposed between a polymer film in the electrostatic capacitance-type touch panel sensor 6 described below and the protective substrate 12 and exhibits predetermined optical characteristics. Meanwhile, the ultraviolet absorption layer 8 is not adhesive and belongs to non-adhesive layers.

The transmittance of the ultraviolet absorption layer 8 in a wavelength range of 200 to 340 nm is 5% or less. That is, the maximum value (%) of the transmittance in a wavelength range of 200 to 340 nm is 5% or less.

Among these, the maximum value is preferably 3% or less and more preferably 2.5% or less since the drop impact durability of the touch panel is superior. The lower limit is not particularly limited, but examples thereof include 0%.

In a case in which the transmittance exceeds 5%, the polymer film is likely to be influenced by ultraviolet rays, and the drop impact durability of the touch panel deteriorates.

The transmittance of the ultraviolet absorption layer 8 is obtained by means of the following measurement and calculation. A sample substrate having the ultraviolet absorption layer 8 formed on a glass substrate is produced, and the total light transmittance (%) of the sample substrate is measured using V-670 manufactured by JASCO Corporation in a wavelength range of 200 to 800 nm. The measurement result of this transmittance (%) is represented by T_{S}(λ) (λ represents wavelengths). The total light transmittance of the glass substrate alone is measured in the same measurement range in the same manner, and the measurement result of this transmittance (%) is represented by T_{B}(λ). The transmittance T_{UV} of the ultraviolet absorption layer 8 is defined by Calculation Equation (1) and can be obtained by means of calculation.

T_{UV}(λ)={T_{S}(λ)/T_{B}(λ)}×100 Equation (1)

For example, in a case in which the respective values of T_{S} and T_{B} at a wavelength of 400 nm are 91.0% (T_{S}) and 92.0% (T_{B}), the transmittance T_{UV} of the ultraviolet absorption layer 8 is obtained to be 98.9%.

In a case in which the touch panel includes the ultraviolet absorption layer, the transmittance T_{UV}′(λ) of the ultraviolet absorption layer included in the touch panel can be obtained by, for example, dissembling the touch panel, measuring the total light transmittance (T_{S}′(λ)) of the touch panel sensor laminate including the ultraviolet absorption layer, on the other hand, measuring the total light transmittance (T_{B}′(λ) of the touch panel sensor laminate not including the ultraviolet absorption layer, and replacing T_{S}(λ) and T_{B}(λ) with T_{S}′(λ) and T_{B}′(λ) respectively in Equation (1), and carrying out calculation.

From the viewpoint of imparting manufacturing suitability for direct bonding methods, the transmittance of the ultraviolet absorption layer 8 at a wavelength of 400 nm needs to be high, and the transmittance at short wavelengths needs to be low in a range in which the cut-off wavelength does not reach 340 nm or shorter.

Therefore, as a requisite condition, the transmittance of the ultraviolet absorption layer 8 at a wavelength of 400 nm is 86% or more, and, from the viewpoint of superior manufacturing suitability for direct bonding methods, the transmittance is preferably 92% or more and more preferably 96% or more. The upper limit is not particularly limited, and examples thereof include 100%.

The method for measuring the transmittance at a wavelength of 400 nm is the same as the method for measuring the transmittance in the above-described wavelength range of 200 to 340 nm.

The transmittance of the ultraviolet absorption layer 8 in a wavelength range of 400 to 800 nm is in a range of ±3% or less of the transmittance at a wavelength of 400 nm. That is, the maximum transmittance difference between the transmittance in a wavelength range of 400 to 800 nm and the transmittance at a wavelength of 400 nm is intended to be ±3% or less. In other words, the difference (X−Z) between the maximum value X (%) of the transmittance in a wavelength range of 400 to 800 nm and the transmittance Z (%) at a wavelength of 400 nm is ±3% or less, and the difference (Y−Z) between the minimum value Y (%) of the transmittance in a wavelength range of 400 to 800 nm and the transmittance Z (%) at a wavelength of 400 nm is ±3% or less.

Among these, from the viewpoint of the superior tone of the touch panel, the above-described numerical range is preferably ±1.5% and more preferably ±0.6%.

Regarding the above-described measurement, the transmittance at a wavelength of 200 to 800 nm is measured and computed in the same manner as in the method for manufacturing the transmittance in the above-described wavelength range of 200 to 340 nm.

The thickness of the ultraviolet absorption layer 8 is not particularly limited as long as the above-described optical characteristics are satisfied. Particularly, from the viewpoint of the balance between handleability and the thickness reduction of the touch panel, the thickness is preferably 100 μm or lower, more preferably 1 to 100 μm, and still more preferably 10 to 60

To the ultraviolet absorption layer 8, an ultraviolet absorbent is added. The kind of the ultraviolet absorbent is not particularly limited as long as the ultraviolet absorption layer 8 satisfies the above-described optical characteristics.

Examples of the ultraviolet absorbent include metal oxide fine particles, benzotriazole-based ultraviolet absorbents, benzophenone-based ultraviolet absorbents, salicylate-based ultraviolet absorbents, cyanoacrylate-based ultraviolet absorbents, nickel-based ultraviolet absorbents, triazine-based ultraviolet absorbents, hydroxyphenyl triazine-based ultraviolet absorbents, and the like. Among these, from the viewpoint of high ultraviolet absorption properties and small influences on the corrosion of metal components in thin conductive lines in the touch panel sensor, benzotriazle-based ultraviolet absorbents or hydroxyphenyl triazine-based ultraviolet absorbents are preferred.

Only one ultraviolet absorbents may be used, or a plurality of ultraviolet absorbents may be jointly used.

The amount of the ultraviolet absorbent used in the ultraviolet absorption layer 8 is not particularly limited as long as the ultraviolet absorption layer 8 exhibits the above-described optical characteristics. Among these, from the viewpoint of the easy control of the optical characteristics, the amount is preferably 0.1 to 1.5 g/m² and more preferably 0.3 to 0.8 g/m².

The ultraviolet absorption layer 8 may include components other than the ultraviolet absorbent, and, for example, the ultraviolet absorption layer 8 may include a binder resin. The inclusion of the binder resin makes the mechanical strength of the ultraviolet absorption layer 8 superior.

The kind of the binder resin is not particularly limited, and examples thereof include at least any resins selected from the group consisting of gelatin, (meth)acrylic resins, styrene-based resins, vinyl-based resins, polyolefin-based resins, polyester-based resins, polyurethane-based resins, polyamide-based resins, polycarbonate-based resins, polydiene-based resins, epoxy-based resins, silicone-based resins, cellulose-based polymers, and chitosan-based polymers, copolymers made of monomers constituting the above-described resins, and the like.

The absolute value of b* of the ultraviolet absorption layer 8, which is obtained according to JIS-Z8729, is not particularly limited, but is preferably less than 1.0 since the tone of the touch panel is superior.

In the method for measuring b* of the ultraviolet absorption layer 8, the result of the transmittance T_{UV}(λ) of the ultraviolet absorption layer 8 obtained as described above is used, and the L* value, a* value, and b* value of transmitted light are computed using the method prescribed in JIS-Z8729:1994.

The method for forming the ultraviolet absorption layer 8 is not particularly limited, and examples thereof include a method in which a composition for forming the ultraviolet absorption layer which includes the above-described ultraviolet absorbent is applied onto the electrostatic capacitance-type touch panel sensor 6 and is then dried as necessary.

Meanwhile, in the case of producing the ultraviolet absorption layer 8, in a case in which an emulsified substance is used as the composition for forming the ultraviolet absorption layer, to the composition for forming the ultraviolet absorption layer, a surfactant may be added.

(Image Display Device)

The image display device 2 is a device having a display surface that displays images and has individual members disposed on the display screen side.

The kind of the image display device 2 is not particularly limited, and well-known image display devices can be used. Examples thereof include cathode-ray tube (CRT) display devices, liquid crystal display devices (LCD), organic light-emitting diode (OLED) display devices, vacuum fluorescent displays (VFD), plasma display panels (PDP), surface-conduction electron-emitter displays (SED), field emission displays (FED), electronic paper (E-Paper), and the like.

(Adhesive Layer (Adhesive Layer Formed by Curing Ultraviolet-Curable Adhesive))

The adhesive layer 4 is a layer for securing the adhesiveness between the image display device 2 and the electrostatic capacitance-type touch panel sensor 6 described below.

The adhesive layer 4 is an adhesive layer formed by curing an ultraviolet-curable adhesive. That is, the adhesive layer 4 is a layer obtained by curing an ultraviolet-curable adhesive by means of irradiation with ultraviolet rays. Meanwhile, as described above, since the ultraviolet-curable adhesive is relatively freely transformable in steps before irradiation with ultraviolet rays, the uniform adhesion and attachment in the entire surface become possible while suppressing the inclusion and the like of the air between the image display device 2 and the electrostatic capacitance-type touch panel sensor 6.

The kind of the ultraviolet-curable adhesive (so-called optically clear adhesive resin (OCR)) is not particularly limited as long as the ultraviolet-curable adhesive cures (senses light) by light having wavelengths of longer than 340 nm and 400 nm or shorter.

As the ultraviolet-curable adhesive, well-known ultraviolet-curable adhesives can be used. Examples of the ultraviolet-curable adhesive include compositions including ultraviolet-curable components (for example, monomers and/or polymers having radically polymerizable unsaturated bonds in the molecule) and, as necessary, a photopolymerization initiator.

Meanwhile, as described above, the ultraviolet-curable adhesive cures by light having a wavelength in a range of longer than 340 nm and 400 nm or shorter. That is, in a case in which the ultraviolet-curable adhesive is irradiated with light having wavelengths of longer than 340 nm and 400 nm or shorter, a curing reaction proceeds, and an adhesive layer (cured layer) that is adhesive is formed.

The thickness of the adhesive layer 4 is not particularly limited, but is preferably 10 to 300 μm and more preferably 50 to 200 μm from the viewpoint of the balance between handleability and the thickness reduction of the touch panel.

(Electrostatic Capacitance-Type Touch Panel Sensor)

The electrostatic capacitance-type touch panel sensor 6 is a sensor which is disposed on the image display device 2 (on the operator side) and detects the location of an external conductor such as a human finger using changes in the electrostatic capacitance caused in a case in which the external conductor such as a human finger comes into contact with (comes close to) the sensor.

The constitution of the electrostatic capacitance-type touch panel sensor 6 is not particularly limited; however, generally, the electrostatic capacitance-type touch panel sensor has detection electrodes (particularly, a detection electrode that extends in an X direction and a detection electrode that extends in an Y direction) and specifies the coordination of a finger by detecting changes in the electrostatic capacitance of the detection electrode to which the finger comes into contact or close.

The electrostatic capacitance-type touch panel sensor 6 includes any one polymer film of a cyclic olefin polymer film and a cyclic olefin copolymer film. More specifically, the electrostatic capacitance-type touch panel sensor 6 has the polymer film and a conduction portion (detection electrodes and/or lead wires) made up of thin conductive lines disposed on at least one surface of the polymer film.

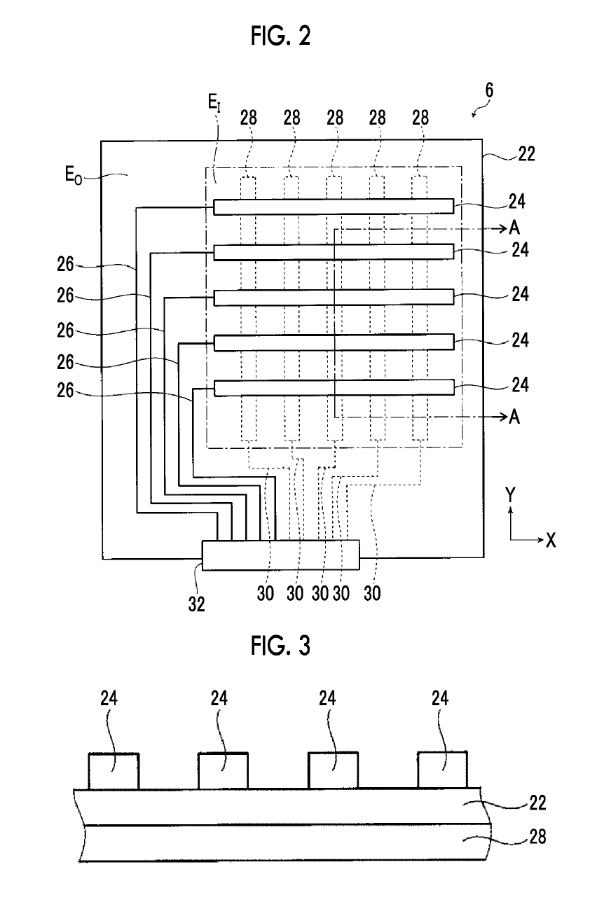

A preferred aspect of the electrostatic capacitance-type touch panel sensor 6 will be described in detail using FIG. 2.

FIG. 2 illustrates a plan view of the electrostatic capacitance-type touch panel sensor 6. FIG. 3 is a cross-sectional view in a direction of the cutting line A-A in FIG. 2. The electrostatic capacitance-type touch panel sensor 6 comprises a polymer film 22, first detection electrodes 24 disposed on one main surface (front surface) of the polymer film 22, first lead wires 26, second detection electrodes 28 disposed on the other main surface (rear surface) of the polymer film 22, second lead wires 30, and a flexible printed circuit board 32. Meanwhile, regions in which the first detection electrodes 24 and the second detection electrodes 28 are present constitute an input region E_{I} (input region in which the contact by an object can be detected (sensing portions)) through which an operator can do input operation, and the first lead wires 26, the second lead wires 30, and the flexible printed circuit board 32 are disposed in an outside region E_{O} located outside the input region E_{I}.

Hereinafter, the above-described constitution will be described in detail.

The polymer film 22 is a member which plays a role of supporting the first detection electrodes 24 and the second detection electrodes 28 in the input region E_{I} and plays a role of supporting the first lead wires 26 and the second lead wires 30 in the outside region E_{O}.

The polymer film 22 is any one of a cyclic olefin polymer film and a cyclic olefin copolymer film.

The cyclic olefin polymer film refers to a film made of a cyclic olefin polymer. The cyclic olefin polymer refers to a polymer made of only cyclic olefins having a cyclic structure. The cyclic olefin polymer may be a copolymer as long as the cyclic olefin is made of only cyclic olefins. Examples of the cyclic olefin include polycyclic cyclic olefins such as norbornene, methyl norbornene, dimethyl norbornene, ethyl norbornene, ethylidene norbornene, butyl norbornene, dicyclopentadiene, dihydroxy dicyclopentadiene, methyl dicyclopentadiene, dimethyl dicyclopentadiene, tetracyclododecene, methyl tetracyclododecene, dimethyl cyclotetradodecene, tricyclopentadiene, and tetracyclopentadiene, monocyclic cyclic olefins such as cyclobutene, cyclopentene, cyclooctene, cyclooctadiene, cyclooctatriene, and cyclododecatriene, and the like. The polymerization method may be ring-opening polymerization or addition polymerization.

The cyclic olefin copolymer film refers to a film made of a cyclic olefin copolymer. The cyclic olefin copolymer refers to a polymer obtained by copolymerizing a monomer made of a cyclic olefin (cyclopentene, norbornene, tetracyclododecene, or the like) and a monomer having an olefin-like double bond such as a non-cyclic polyolefin-based monomer (particularly, ethylene is preferred) or an acrylic monomer (methyl methacrylate, methyl acrylate, or the like).

Examples of commercially available products of the polymer film 22 include ARTON (cyclic olefin polymer: COP) manufactured by JSR Corporation, ZEONOR (COP) manufactured by Zeon Corporation, TOPAS (cyclic olefin copolymer: COC) manufactured by Polyplastics Co., Ltd., APEL (COC) manufactured by Mitsui Chemicals Tohcello, Inc., F 1 film (COC) manufactured by Gunze Limited., and the like.

The polymer film 22 preferably transmits light appropriately. Specifically, the total light transmittance of the polymer film 22 is preferably 85% to 100%.

The thickness of the polymer film 22 is not particularly limited, but is preferably 5 to 350 μm and more preferably 30 to 150 μm. In a case in which the thickness is in the above-described range, desired visible light transmittances can be obtained, and the polymer film can also be easily handled.

In addition, in FIG. 2, the planar shape of the polymer film 22 is substantially rectangular, but the planar shape is not limited thereto. For example, the planar shape may be circular or polygonal.

The first detection electrode 24 and the second detection electrode 28 are sensing electrodes that sense changes in electrostatic capacitances and constitute a sensing portion. That is, in a case in which a fingertip is brought into contact with the touch panel, the mutual electrostatic capacitance between the first detection electrode 24 and the second detection electrode 28 changes, and the location of the fingertip is computed using an integrated circuit (IC) on the basis of the amount of the change.

The first detection electrode 24 plays a role of detecting the input location of a finger of an operator, which comes close to the input region E_{I}, in the X direction and has a function of generating an electrostatic capacitance between the finger and the first detection electrode. The first detection electrodes 24 are electrodes which extend in a first direction (X direction) and are arranged in a second direction (Y direction) orthogonal to the first direction at predetermined intervals and include a predetermined pattern as described below.

The second detection electrode 28 plays a role of detecting the input location of the finger of the operator, which comes close to the input region E_{I}, in the Y direction and has a function of generating an electrostatic capacitance between the finger and the second detection electrode. The second detection electrodes 28 are electrodes which extend in a second direction (Y direction) and are arranged in the first direction (X direction) at predetermined intervals and include a predetermined pattern as described below. In FIG. 2, the number of the first detection electrodes 24 provided is five, and the number of the second detection electrodes 28 provided is five, but the numbers are not particularly limited and may be plural.

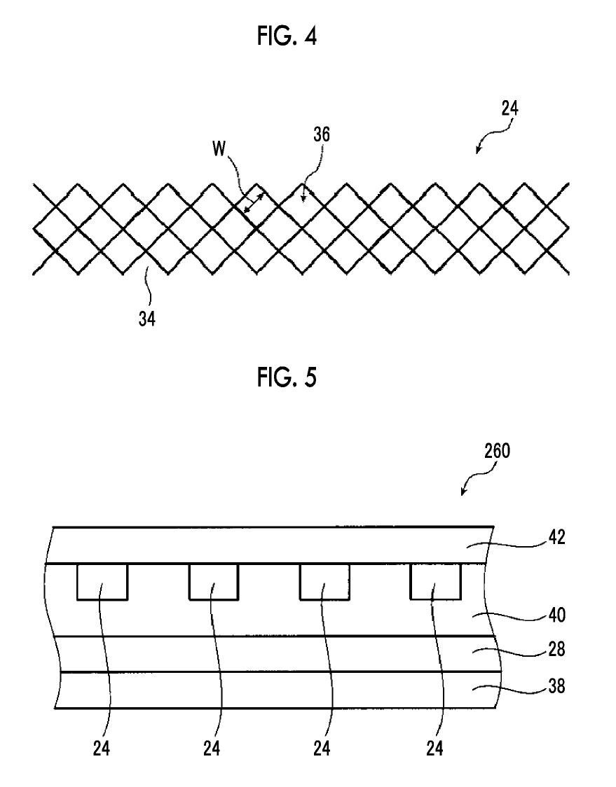

In FIG. 2, the first detection electrode 24 and the second detection electrode 28 are constituted of thin conductive lines. FIG. 4 illustrates an enlarged plan view of a part of the first detection electrode 24. As illustrated in FIG. 4, the first detection electrode 24 is constituted of thin conductive lines 34 and includes a plurality of lattices 36 formed by the thin conductive lines 34 intersecting each other. That is, a mesh shape (mesh pattern) is formed by the thin conductive lines 34. Meanwhile, the second detection electrode 28 also, similar to the first detection electrode 24, includes a plurality of the lattices 36 formed by the thin conductive lines 34 intersecting each other.

Examples of the material of the thin conductive line 34 include metals such as gold (Au), silver (Ag), copper (Cu), aluminum (Al), and palladium (Pd), alloys thereof (for example, silver-palladium alloys and silver-palladium-copper alloys), metal oxides such as indium tin oxide (ITO), tin oxide, zinc oxide, cadmium oxide, potassium oxide, and titanium oxide, and the like. Among these, from the viewpoint of the excellent conductivity of the thin conductive line 34, silver is preferred.

The thin conductive line 34 preferably includes a binder from the viewpoint of the adhesiveness between the thin conductive lines 34 and the polymer film 22.

The binder is preferably a water-soluble macromolecule due to the superior adhesiveness between the thin conductive lines 34 and the polymer film 22. Examples of the kind of the binder include polysaccharides such as gelatin, carrageenan, polyvinyl alcohol (PVA), polyvinyl pyrrolidone (PVP), and starch, cellulose and derivatives thereof, polyethylene oxide, polysaccharides, polyvinyl amines, chitosan, polylysine, polyacrylic acid, polyalginic acid, polyhyaluronic acid, carboxy cellulose, gum Arabic, sodium alginate, and the like. Among these, gelatin is preferred due to the superior adhesiveness between the thin conductive lines 34 and the polymer film 22.

The line width of the thin conductive line 34 is not particularly limited, but is preferably 30 μm or less, more preferably 15 μm or less, still more preferably 10 μm or less, particularly preferably 9 μm or less, most preferably 7 μm or less and preferably 0.5 μm or more and more preferably 1 μm or more since it is possible to relatively easily form low-resistance electrodes.

The thickness of the thin conductive line 34 is not particularly limited, but can be selected from 0.00001 to 0.2 mm and is preferably 30 μm or less, more preferably 20 μm or less, still more preferably 0.01 to 9 μm, and most preferably 0.05 to 5 μm from the viewpoint of conductivity and visibility.

The lattice 36 includes an open region surrounded by the thin conductive lines 34. The length W of one side of the lattice 36 is preferably 1,500 μm or less, more preferably 1,300 μm or less, and still more preferably 1,000 μm or less and preferably 5 μm or more, more preferably 30 μm or more, and still more preferably 80 μm or more.

In the first detection electrode 24 and the second detection electrode 28, the opening ratio is preferably 85% or more, more preferably 90% or more, and still more preferably 95% or more from the viewpoint of the visible light transmittance. The opening percentage corresponds to the proportion of transmissible portions excluding the thin conductive lines 34 in the first detection electrode 24 or the second detection electrode 28 to the entire area of a predetermined region.

The lattice 36 has a substantially rhombic shape. However, the lattice may have a different polygonal shape (for example, a triangular shape, a quadrangular shape, a hexagonal shape, or a random polygonal shape). In addition, the shape of the side may be a curved shape or an arc shape as well as a straight shape. In a case in which the shape of the side is an arc shape, two facing sides may have an arc shape that protrudes outwards, and the rest two sides may have an arc shape that protrudes inwards. In addition, the combined shape of the respective sides may be a wavy shape in which arcs protruding outwards and arcs protruding inwards continue. It is needless to say that the combined shape of the respective sides may be a sine curve.

Meanwhile, in FIG. 4, the thin conductive lines 34 form a mesh pattern, but the pattern is not limited thereto, and a stripe pattern may be formed.

Meanwhile, in FIG. 2, the first detection electrode 24 and the second detection electrode 28 are constituted of a mesh structure of the thin conductive lines 34, but the aspect is not limited thereto. For example, all of the first detection electrode 24 and the second detection electrode 28 may be formed of a fine metal oxide film (transparent fine metal oxide film) of ITO, ZnO, or the like.

In addition, the pattern of the electrode can be selected depending on the material of the electrode, and a photolithography method, a resist mask screen printing-etching method, an inject method, a printing method, or the like may also be used.

The first lead wires 26 and the second lead wires 30 are members playing a role of applying voltages to the first detection electrodes 24 and the second detection electrodes 28 respectively.

The first lead wire 26 is disposed on the polymer film 22 in the outside region E_{O}, is electrically connected to the first detection electrode 24 at one end, and is electrically connected to the flexible printed circuit board 32 at the other end.

The second lead wire 30 is disposed on the polymer film 22 in the outside region E_{O}, is electrically connected to the second detection electrode 28 at one end, and is electrically connected to the flexible printed circuit board 32 at the other end.

Meanwhile, in FIG. 2, the number of the first lead wires 26 illustrated is five, and the number of the second lead wires 30 illustrated is five, but the numbers are not particularly limited, and, generally, a plurality of wires are disposed depending on the number of the detection electrodes.

Examples of the material constituting the first lead wire 26 and the second lead wire 30 include metals such as gold (Au), silver (Ag), and copper (Cu), metal oxides such as tin oxide, zinc oxide, cadmium oxide, potassium oxide, and titanium oxide, and the like. Among these, silver is preferred due to its excellent conductivity.

Meanwhile, the first lead wire 26 and the second lead wire 30 preferably include a binder from the viewpoint of the superior adhesiveness to the polymer film 22. The kind of the binder is as described above.

The flexible printed circuit board 32 is a plate having a plurality of wires and terminal provided on a substrate, is connected to the other ends of the first lead wires 26 respectively and the other ends of the second lead wires 30 respectively, and plays a role of connecting the electrostatic capacitance-type touch panel sensor 6 and external devices (for example, image display devices).

The aspect of the electrostatic capacitance-type touch panel sensor is not limited to the aspect of FIG. 3 and may be a different aspect.

For example, as illustrated in FIG. 5, an electrostatic capacitance-type touch panel sensor 260 comprises a first polymer film 38, the second detection electrodes 28 disposed on the first polymer film 38, second lead wires which are electrically connected to the one ends of the second detection electrodes 28 and disposed on the first polymer film 38 (not illustrated), an adhesive layer 40, the first detection electrodes 24, first lead wires which are electrically connected to one ends of the first detection electrodes 24 (not illustrated), a second polymer film 42 to which the first detection electrodes 24 and the first lead wires are adjacent, and a flexible printed circuit board (not illustrated).

As illustrated in FIG. 5, since the electrostatic capacitance-type touch panel sensor 260 has the same constitution as the electrostatic capacitance-type touch panel sensor 6 except for the first polymer film 38, the second polymer film 42, and the adhesive layer 40, the same constituent elements will be given the same reference sign and will not be described again.

The definitions of the first polymer film 38 and the second polymer film 42 are the same as the above-described definition of the polymer film 22.

The adhesive layer 40 is a layer for the adhesion of the first detection electrodes 24 and the second detection electrodes 28 and is preferably optically transparent (preferably a transparent adhesive layer). As the material constituting the adhesive layer 40, well-known materials are used.

The numbers of the first detection electrodes 24 and the second detection electrodes 28 used in FIG. 5 are respectively plural as illustrated in FIG. 4, and both electrodes are disposed so as to be orthogonal to each other as illustrated in FIG. 4.

Meanwhile, the electrostatic capacitance-type touch panel sensor 260 illustrated in FIG. 5 corresponds to an electrostatic capacitance-type touch panel sensor obtained by preparing two electrode-attached polymer films having a polymer film and detection electrodes and lead wires disposed on the surface of the polymer film and attaching the electrode-attached polymer films through an adhesive layer so that the electrodes face each other.

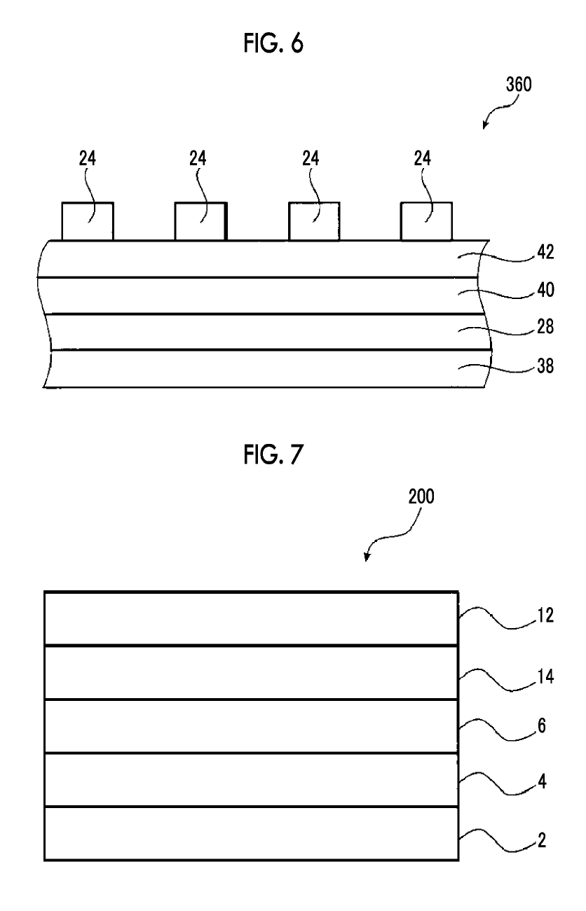

Examples of other aspects of the electrostatic capacitance-type touch panel sensor include an aspect illustrated in FIG. 6.

An electrostatic capacitance-type touch panel sensor 360 comprises the first polymer film 38, the second detection electrodes 28 disposed on the first polymer film 38, second lead wires which are electrically connected to the one ends of the second detection electrodes 28 and disposed on the first polymer film 38 (not illustrated), the adhesive layer 40, the second polymer film 42, the first detection electrodes 24 disposed on the second polymer film 42, first lead wires which are electrically connected to one ends of the first detection electrodes 24 and disposed on the second polymer film 42 (not illustrated), and a flexible printed circuit board (not illustrated).

Since the electrostatic capacitance-type touch panel sensor 360 illustrated in FIG. 6 has the same layers as the electrostatic capacitance-type touch panel sensor 260 illustrated in FIG. 5 except for the fact that the order of the respective layers is different, the same constituent elements will be given the same reference sign and will not be described again.

In addition, the numbers of the first detection electrodes 24 and the second detection electrodes 28 used in FIG. 6 are respectively plural as illustrated in FIG. 4, and both electrodes are disposed so as to be orthogonal to each other as illustrated in FIG. 4.

Meanwhile, the electrostatic capacitance-type touch panel sensor 360 illustrated in FIG. 6 corresponds to an electrostatic capacitance-type touch panel sensor obtained by preparing two electrode-attached polymer films having a polymer film and detection electrodes and lead wires disposed on the surface of the polymer film and attaching the electrode-attached polymer films through an adhesive layer so that the polymer film in one electrode-attached polymer film and the electrodes in the other electrode-attached polymer film face each other.

(Upper Adhesive Layer)

The upper adhesive layer 10 is a layer for securing the adhesiveness between the ultraviolet absorption layer 8 and the protective substrate 12 described below.

As the material constituting the upper adhesive layer 10, well-known adhesives are preferably used, and examples thereof include acrylic adhesives, rubber-based adhesives, silicone-based adhesives, and the like. Among these, acrylic adhesives are preferred due to their excellent transparency.

The thickness of the upper adhesive layer 10 is not particularly limited, but is preferably 5 to 350 μm, more preferably 30 to 250 μm, and still more preferably 30 to 150 μm. In a case in which the thickness is in the above-described range, desired visible light transmittances can be obtained, and the upper adhesive layer can also be easily handled.

The upper adhesive layer 10 is preferably optically transparent. That is, the upper adhesive layer 10 is preferably a transparent adhesive layer. Being optically transparent indicates that the total light transmittance is 85% or more, preferably 90% or more, and more preferably 100%.

(Protective Substrate)

The protective substrate 12 is a substrate that is disposed on the upper adhesive layer 10 and plays a role of protecting the electrostatic capacitance-type touch panel sensor 6 described below or the image display device 2 from external environments, and the main surface of the protective substrate constitutes the touch surface.

The protective substrate is preferably a transparent substrate, and glass plates (cover glass), plastic plates (plastic films), or the like are used. It is desirable to appropriately select the thickness of the substrate depending on a variety of usages.

As the material constituting the plastic plate, it is possible to use, for example, polyesters such as polyethylene terephthalate (PET) and polyethylene naphthalate (PEN); polyolefins such as polyethylene (PE), polypropylene (PP), and polystyrene; vinyl-based resins; additionally, polycarbonate (PC), polyamide, polyimide, acrylic resins, triacetyl cellulose (TAC), cycloolefin-based resins (COP and COC), and the like.

In addition, as the protective substrate 12, polarizing plates, circularly polarizing plates, and the like may be used.

<Method for Manufacturing Electrostatic Capacitance-Type Touch Panel Sensor and Touch Panel>

The method for manufacturing the above-described touch panel 100 is not particularly limited, and well-known methods can be employed.

Hereinafter, first, the method for manufacturing the electrostatic capacitance-type touch panel sensor 6 will be described in detail.

(Method for Manufacturing Electrostatic Capacitance-Type Touch Panel Sensor)

The method for manufacturing the electrostatic capacitance-type touch panel sensor 6 is not particularly limited, and well-known methods can be employed. Examples thereof include a method in which exposure and a development treatment are carried out on photoresist films on metal foils formed on both main surfaces of the polymer film 22 so as to fonn resist patterns and the metal foils exposed through the resist patterns are etched. In addition, examples thereof also include a method in which paste including fine metal particles or metal nanowires is printed on both main surfaces of the polymer film 22 and metal plating is carried out on the paste. In addition, examples thereof also include a method in which patterns are printed and formed using a screen printing plate or a gravure printing plate on the polymer film 22 and a method in which patterns are formed using ink jets.

Furthermore, examples thereof include, in addition to the above-described methods, a method in which silver halides are used. More specific examples thereof include a method having a step (1) of forming silver halide emulsion layers containing a silver halide and a binder (hereinafter, also simply referred to as photosensitive layers) on both surfaces of the polymer film 22 respectively and a step (2) of exposing and then developing the photosensitive layers.

Hereinafter, the respective steps will be described.

[Step (1): Step of Forming Photosensitive Layers]

Step (1) is a step of forming photosensitive layers containing a silver halide and a binder on both surfaces of the polymer film 22.

The method for forming the photosensitive layers is not particularly limited, but a method in which a composition for forming the photosensitive layers which contains a silver halide and a binder is brought into contact with the polymer film 22 and photosensitive layers are formed on both surfaces of the polymer film 22 is preferred from the viewpoint of productivity.

Hereinafter, an aspect of the composition for forming the photosensitive layers which is used in the above-described method will be described in detail, and then the order of the step will be described in detail.

To the composition for forming the photosensitive layers, a silver halide and a binder are added.

A halogen element contained in the silver halide may be any one of chlorine, bromine, iodine, and fluorine or a combination thereof. As the silver halide, for example, a silver halide mainly containing silver chloride, silver bromide, or silver iodide is preferably used, and furthermore, a silver halide mainly containing silver bromide or silver chloride is preferably used.

The kind of the binder being used is as described above. In addition, the binder may be included in the composition for forming the photosensitive layers in a latex form.

The volume ratio between the silver halide and the binder in the composition for forming the photosensitive layers is not particularly limited and is appropriately adjusted so as to be in a preferred range of the volume ratio between metal and the binder in the above-described thin conductive lines 34.

To the composition for forming the photosensitive layers, a solvent is added.

Examples of the solvent being used include water, organic solvents (for example, alcohols such as methanol, ketones such as acetone, amides such as formamide, sulfoxides such as dimethyl sulfoxide, esters such as ethyl acetate, ethers, and the like), ionic liquids, and solvent mixtures thereof

(Order of Step)

The method for bringing the composition for forming the photosensitive layers into contact with the polymer film 22 is not particularly limited, and a well-known method can be employed. Examples thereof include a method in which the composition for forming the photosensitive layers is applied to the polymer film 22, a method in which the polymer film 22 is immersed in the composition for forming the photosensitive layers, and the like.

Meanwhile, a protective layer made of the binder may be further provided on the photosensitive layer as necessary. The provision of the protective layer prevents scratches or improves dynamic characteristics.

[Step (2): Exposure and Development Step]

Step (2) is a step of exposing and then developing the patterns of the photosensitive layers obtained by Step (1), thereby forming the first detection electrodes 24, the first lead wires 26, the second detection electrodes 28, and the second lead wires 30.

First, hereinafter, a pattern exposure treatment will be described in detail, and then a development treatment will be described in detail.

(Pattern Exposure)

In a case in which a pattern on the photosensitive layer is exposed, the silver halide in the photosensitive layer forms latent images in exposed regions. The regions in which the latent images are formed from the detection electrodes and the lead wires in a case in which a development treatment described below is carried out thereon. On the other hand, in non-exposed regions which are not exposed, the silver halide dissolves and flows out from the photosensitive layer in the case of a fixation treatment described below, and transparent films are obtained.

A light source that is used in the case of exposure is not particularly limited, and examples thereof include light such as visible light rays and ultraviolet rays, radiant rays such as X-rays, and the like.

The method for exposing the patterns is not particularly limited, and, for example, the patterns may be exposed by means of surface exposure using photo masks or scanning exposure using laser beams. Meanwhile, the shape of the pattern is not particularly limited and is appropriately adjusted to the pattern of thin conductive lines that need to be formed.

(Development Treatment)

The method for the development treatment is not particularly limited, and a well-known method can be employed. For example, it is possible to use ordinary development treatment techniques that are used for silver halide photographic films, printing paper, films for making printing plates, emulsion masks for photo masks, and the like.

The kind of a developer that is used in the case of the development treatment is not particularly limited, and, for example, phenidone hydroquinone (PQ) developers, metol hydroquinone (MQ) developers, metol ascorbic acid (MAA) developers, and the like can also be used.

The development treatment may include the fixation treatment which is intended to remove silver salts in the non-exposed portions and stabilize the non-exposed portions. For the fixation treatment, it is possible to use techniques of fixation treatments that are used for silver salt photograph films, developing paper, films for producing printing plates, emulsion masks for photo masks, and the like.

The fixation temperature in a fixation step is preferably 20° C. to 50° C. and more preferably 25° C. to 45° C. In addition, the fixation time is preferably 5 seconds to 1 minute and more preferably 7 to 50 seconds.

In addition to the above-described steps, an undercoat formation step, an antihalation layer formation step, which are described below, or a heating treatment may be carried out as necessary.

(Undercoat Formation Step)

Before Step (1), a step of forming undercoats including the binder on both surfaces of the polymer film 22 is preferably carried out since the adhesiveness between the polymer film 22 and the silver halide emulsion layers becomes excellent.

The binder being used is as described above. The thickness of the undercoat is not particularly limited, but is preferably 0.01 to 0.5 μm and more preferably 0.01 to 0.1 μm from the viewpoint of adhesiveness and the additional suppression of the change ratio of the mutual electrostatic capacitance.

(Antihalation Layer Formation Step) From the viewpoint of thinning the thin conductive lines 34, before Step (1), a step of forming antihalation layers on both surfaces of the polymer film 22 is preferably carried out.

(Step (3): Heating step)

Step (3) is carried out as necessary and is a step of carrying out a heating treatment after the development treatment. In a case in which the present step is carried out, binder particles fuse together, and the hardness of the detection electrodes and the lead wires further increases. Particularly, in a case in which polymer particles are dispersed in the composition for forming the photosensitive layers as the binder (in a case in which the binder is polymer particles in latex), in a case in which the present step is carried out, the polymer particles fuse together, and detection electrodes and lead wires which exhibit desired hardness are formed.

(Method for Forming Touch Panel)

As one of the embodiments of the method for manufacturing a touch panel, first, the ultraviolet absorption layer 8 is formed on one surface of the electrostatic capacitance-type touch panel sensor 6.

Examples of the method for forming the ultraviolet absorption layer 8 include a method in which a composition for forming the ultraviolet absorption layer including a predetermined ultraviolet absorbent is applied onto the electrostatic capacitance-type touch panel sensor 6 and is dried as necessary as described above.

Next, examples of the method for forming the upper adhesive layer 10 on the ultraviolet absorption layer 8 include a method in which an adhesive layer sheet (so-called optically clear adhesive film (OCA)) is attached to the ultraviolet absorption layer 8 and a method in which a liquid-phase adhesive composition (so-called ultraviolet (UV)-curable adhesive) or a transparent adhesive (OCR) is applied onto the ultraviolet absorption layer 8 and is cured as necessary.

Next, the protective substrate 12 is attached onto the upper adhesive layer 10, thereby forming a touch panel sensor-containing laminate made up of the electrostatic capacitance-type touch panel sensor 6, the upper adhesive layer 10, and the protective substrate 12. As the attachment method, well-known methods can be employed.

Next, the electrostatic capacitance-type touch panel sensor 6-side surface of the touch panel sensor-containing laminate and the display surface of the image display device 2 are attached together through an ultraviolet-curable adhesive, and ultraviolet rays are radiated on the touch panel sensor-containing laminate side (protective substrate 12 side) so as to cure the ultraviolet-curable adhesive and form the adhesive layer 4, thereby a touch panel 100.

### Second Embodiment

FIG. 7 is a cross-sectional view of a second embodiment of the touch panel of the present invention.

As illustrated in FIG. 7, a touch panel 200 comprises the image display device 2, the adhesive layer 4 formed by curing an ultraviolet-curable adhesive, the electrostatic capacitance-type touch panel sensor 6, an ultraviolet absorbent-containing adhesive layer 14, and the protective substrate 12 in this order.

The touch panel 200 has the same constitution as the constitution (the image display device 2, the adhesive layer 4 formed by curing an ultraviolet-curable adhesive, the electrostatic capacitance-type touch panel sensor 6, and the protective substrate 12) of the above-described touch panel 100 except for the fact that the ultraviolet absorbent-containing adhesive layer 14 is provided, the same constitutent elements will be given the same reference sign and will not be described again. Hereinafter, the ultraviolet absorbent-containing adhesive layer 14 will be described in detail.

The ultraviolet absorbent-containing adhesive layer 14 is a adhesive layer including an ultraviolet absorbent. That is, the ultraviolet absorbent-containing adhesive layer 14 is a layer for securing the adhesiveness between the electrostatic capacitance-type touch panel sensor 6 and the protective substrate 12 and has a function as an ultraviolet absorption layer.

The ultraviolet absorbent-containing adhesive layer 14 exhibits the optical characteristics that the ultraviolet absorption layer 8 described in the first embodiment exhibits. That is, the transmittance of the ultraviolet absorbent-containing adhesive layer 14 in a wavelength range of 200 to 340 nm is 5% or less, the transmittance of the ultraviolet absorbent-containing adhesive layer 14 at a wavelength of 400 nm is 80% or more, and the transmittance of the ultraviolet absorbent-containing adhesive layer 14 in a wavelength range of 400 to 800 nm is in a range of ±3% or less of the transmittance at a wavelength of 400 nm. Preferred aspects of the respective ranges are the same as those in Embodiment 1.

The kind of the ultraviolet absorbent in the ultraviolet absorbent-containing adhesive layer 14 is as described above.

In addition, examples of an adhesive constituting the ultraviolet absorbent-containing adhesive layer 14 include the adhesive constituting the upper adhesive layer 10 described in the first embodiment.

The thickness of the ultraviolet absorbent-containing adhesive layer 14 is not particularly limited as long as the above-described optical characteristics are satisfied. Particularly, from the viewpoint of the balance between handleability and the thickness reduction of the touch panel, the thickness is preferably 10 to 300 μm and more preferably 50 to 200 μm.

The method for manufacturing the ultraviolet absorbent-containing adhesive layer 14 is not particularly limited, and examples thereof include a method in which the ultraviolet absorbent-containing adhesive layer 14 is formed using a composition for forming an adhesive layer including an ultraviolet absorbent.

### Third Embodiment

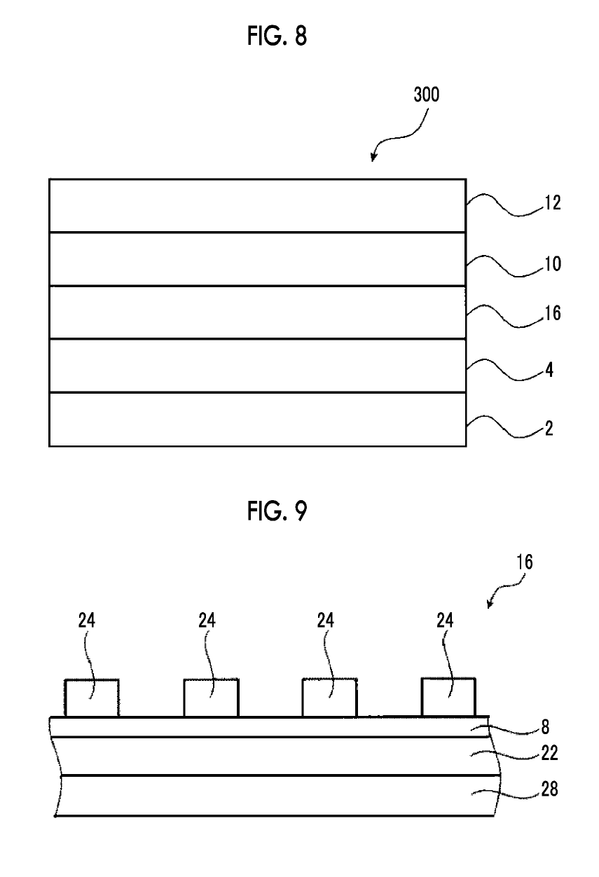

FIG. 8 is a cross-sectional view of a third embodiment of the touch panel of the present invention.

As illustrated in FIG. 8, a touch panel 300 comprises the image display device 2, the adhesive layer 4 formed by curing an ultraviolet-curable adhesive, an electrostatic capacitance-type touch panel sensor 16, the upper adhesive layer 10, and the protective substrate 12 in this order.

The touch panel 300 has the same constitution as the constitution (the image display device 2, the adhesive layer 4 formed by curing an ultraviolet-curable adhesive, the upper adhesive layer 10, and the protective substrate 12) of the above-described touch panel 100 except for the fact that the electrostatic capacitance-type touch panel sensor 16 is provided, the same constitutent elements will be given the same reference sign and will not be described again. Hereinafter, the electrostatic capacitance-type touch panel sensor 16 will be described in detail.

FIG. 9 is a cross-sectional view of the electrostatic capacitance-type touch panel sensor 16.

The electrostatic capacitance-type touch panel sensor 16 that is used in the third embodiment has the same constitution as the electrostatic capacitance-type touch panel sensor 6 that is used in the first embodiment except for the fact that the ultraviolet absorption layer 8 is disposed on the polymer film 22. The ultraviolet absorption layer 8 is disposed on the protective substrate 12-side surface of the polymer film 22 and prevents ultraviolet rays having specific wavelengths from being radiated on the polymer film 22.

The constitution of the ultraviolet absorption layer 8 is the same as the constitution of the ultraviolet absorption layer 8 in the first embodiment.

In addition, as described above, the undercoats or the antihalation layers may be disposed on the polymer film 22, and it is also possible to add an ultraviolet absorbent to these layers and make the layers function as ultraviolet absorption layers.

### EXAMPLES

Hereinafter, the present invention will be described in more detail using examples, but the present invention is not limited thereto.

<Evaluation Experiment of Ultraviolet Durability of COP Film or COC Film>

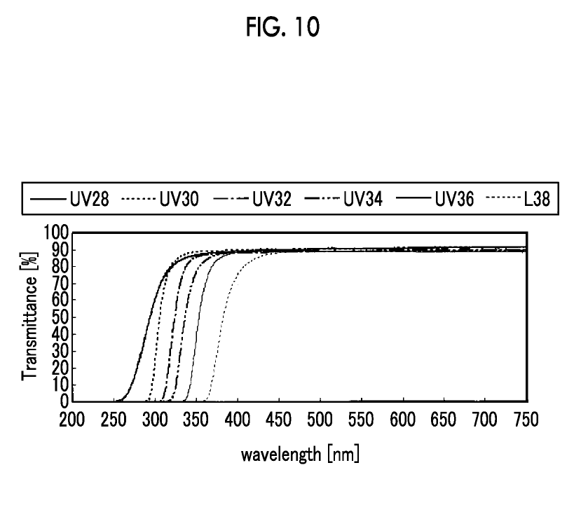

Investigations were carried out using sharp cut filters manufactured by HOYA Corporation in order to clarify cut wavelengths necessary to impart ultraviolet durability to COP films or COC films. UV28, UV30, UV32, UV34, UV36, and L38 were used as the sharp cut filters (the transmission spectra of the respective filters are as illustrated in FIG. 10).

Touch panels not including the ultraviolet absorption layer were produced in the same order as in Example A described below, the respective sharp cut filters were installed between a Xe lamp and the touch panels, irradiation was carried out using the Xe lamp for 200 hours, and then the drop impact durability, which will be described below, of the touch panels were investigated. As a result, touch panels irradiated with ultraviolet rays through the filters of UV34, UV32, UV30, and UV28 were determined to have B-grade drop impact durability, and touch panels irradiated with ultraviolet rays through the filters of UV36 and L38 were determined to have A-grade drop impact durability. From this verification, it was clarified that, in a case in which ultraviolet rays having wavelengths of 340 nm or shorter are cut, in touch panels having COP films or COC films as the substrates, the substrates do not easily deteriorate due to ultraviolet rays.

### Example A

(Touch Panel 101)

ZF14-100 manufactured by Zeon Corporation (100 μm-thick cyclic olefin polymer film) was used as the COP film, and electrode wires for touch panels which were made of silver mesh patterns were disposed on both surfaces of the COP film in the following order, thereby producing a touch panel sensor.

[Manufacturing of Touch Panel Sensor]

(Preparation of Silver Halide Emulsion)

To Liquid 1 that had been stored at 38° C. and a pH of 4.5, 90% (in terms of the amount) of Liquid 2 and Liquid 3 were respectively added at the same time for 20 minutes under stirring, thereby forming 0.16 μm nuclear particles. Subsequently, Liquid 4 and Liquid 5 were added thereto for eight minutes, and furthermore, the remaining 10% of Liquid 2 and Liquid 3 were added for two minutes, thereby growing the nuclear particles to 0.21 μm. Furthermore, potassium iodide (0.15 g) was added thereto, and the mixture was aged for five minutes, thereby completing the formation of the particles.

| Liquid 1: | | |
|---|---|---|
| Water | 750 | ml |
| Gelatin | 9 | g |
| Sodium chloride | 3 | g |
| 1,3-Dimethylimidazolidine-2-thione | 20 | mg |
| Sodium benzenethiosulfate | 10 | mg |
| Citric acid | 0.7 | g |
| Liquid 2: | | |
| Water | 300 | ml |
| Silver nitrate | 150 | g |
| Liquid 3: | | |
| Water | 300 | ml |
| Sodium chloride | 38 | g |
| Potassium bromide | 32 | g |
| Potassium hexachloroiridate (III) | 8 | ml |
| (0.005% of KCl and 20% of an aqueous solution) | | |
| Ammonium hexachlororhodate | 10 | ml |
| (0.001% of NaCl and 20% of an aqueous solution) | | |
| Liquid 4: | | |
| Water | 100 | ml |
| Silver nitrate | 50 | g |
| Liquid 5: | | |
| Water | 100 | ml |
| Sodium chloride | 13 | g |
| Potassium bromide | 11 | g |
| Yellow prussiate of potash | 5 | mg |

After that, the particles were washed with water using a flocculation method according to an ordinary method. Specifically, the temperature was lower to 35° C., and the pH was lowered until silver halides sedimented using sulfuric acid (the pH was in a range of 3.6±0.2). Next, approximately three liters of the supernatant solution was removed (first water washing). Furthermore, three liters of distilled water was added thereto, and then sulfuric acid was added thereto until the silver halides sedimented. Again, three liters of the supernatant solution was removed (second water washing). The same operation as the second water washing was repeated one more time (third water washing), thereby completing a water washing and desalination step. The emulsion after water washing and desalination was adjusted to a pH of 6.4 and a pAg of 7.5, gelatin (3.9 g), sodium benzenethiosulfate (10 mg), sodium benzenethiosulfinate (3 mg), sodium thiosulfate (15 mg), and chlorauric acid (10 mg) were added thereto, chemical sensitization was carried out at 55° C. so as to obtain an optimal sensitivity, and 1,3,3a,7-tetraazaindene (100 mg) as a stabilizer and PROXEL (trade name, manufactured by ICI Co., Ltd.) (100 mg) as a preservative were added thereto. The finally-obtained emulsion was a silver iodochlorobromide cubic particle emulsion which included silver iodide (0.08 mol %) and silver chlorobromide in which the proportions of silver chloride and silver bromide were set to 70 mol % and 30 mol % and had an average particle diameter of 0.22 μm and a coefficient of variation of 9%.

(Preparation of Composition for Forming Photosensitive Layer)

To the emulsion, 1,3,3a,7-tetraazaindene (1.2×10⁻⁴ mol/mol Ag), hydroquinone (1.2×10⁻² mol/mol Ag), citric acid (3.0×10⁻⁴ mol/mol Ag), and 2,4-dichloro-6-hydroxy-1,3,5-triazine sodium salt (0.90 g/mol Ag) were added, and the pH of a coating fluid was adjusted to 5.6 using citric acid, thereby obtaining a composition for forming a photosensitive layer.

(Undercoat Formation Step)

The following components were mixed together, thereby preparing a composition for forming an undercoat.

| | |
|---|---|
| Acrylic polymer | 66.4 parts by mass |
| (AS-563A, manufactured by Daicel FineChem | |
| Ltd., solid content: 27.5% by mass) | |
| Carbodiimide-based crosslinking agent | 16.6 parts by mass |
| (CARBODILITE V-02-L2, manufactured by | |
| Nisshinbo Holdings Inc., solid content: | |
| 10% by mass) | |
| Colloidal silica | 4.4 parts by mass |
| (SNOWTEX XL, manufactured by Nissan | |
| Chemical Industries, Ltd., solid content: 10% | |
| by mass water dilution) | |
| Slipping agent: Carnauba wax | 27.7 parts by mass |
| (SELOSOL 524, manufactured by Chukyo Yushi | |
| Co., Ltd., solid content: 3% by mass water | |
| dilution) | |
| Surfactant: Anionic surfactant | 23.3 parts by mass |
| (RAPISOL A-90, manufactured by NOF | |
| Corporation, solid content: 1% by mass | |
| aqueous solution) | |
| Surfactant: Nonionic surfactant | 14.6 parts by mass |
| (NAROACTY CL95, manufactured by Sanyo | |
| Chemical Industries, Ltd., solid content: 1% by | |
| mass aqueous solution) | |
| Distilled water | 847.0 parts by mass |

A corona discharge treatment was carried out on one surface of the COP film under a condition of 5 kJ/m², and the composition for forming an undercoat was applied to the corona discharge-treated surface so as to obtain a film thickness of 60 nm after drying and was dried at 90° C. for one minute, thereby Ruining an undercoat. An undercoat was also foimed on the other surface of the COP film in the same manner.

(Photosensitive Layer Formation Step)

In the COP film having the undercoats formed on both surfaces, antihalation layers which had an optical density of approximately 1.0 and included a dye that was decolored by alkalis in developers were further provided on the undercoats. The composition for forming a photosensitive layer was applied onto the antihalation layers, and furthermore, 0.15 μm-thick gelatin layers were provided, thereby obtaining a COP film having photosensitive layers formed on both surfaces. The obtained film was used as Film A. In the formed photosensitive layer, the amount of silver was 6.0 g/m², and the amount of gelatin was 1.0 g/m².

(Exposure and Development Step)

Both surfaces of Film A were exposed to parallel light generated from a high-pressure mercury lamp as a light source through a photo mask having an opening portion for the portions of detection electrodes (first detection electrodes and second detection electrodes) and lead wires (first lead wires and second lead wires) as illustrated in FIG. 2. After the exposure, both surfaces were developed using the following developer, and furthermore, a fixation treatment was carried out using a fixation liquid (trade name: N3X-R for CN16X, manufactured by Fujifilm Corporation). Furthermore, both surfaces were rinsed with pure water and dried, thereby obtaining an electrostatic capacitance-type touch panel sensor comprising the detection electrodes made of thin Ag lines and the lead wires on both surfaces.

Meanwhile, in the obtained electrostatic capacitance-type touch panel sensor, the detection electrodes are constituted of thin conductive lines intersecting each other in a mesh shape. In addition, as described above, the first detection electrodes are electrodes extending in the X direction, the second detection electrodes are electrodes extending in the Y direction, and the electrodes are respectively disposed on the film at the pitch of 4.5 to 5.0 mm.

An ultraviolet absorption layer was provided on one surface of the touch panel sensor using the following composition for forming the ultraviolet absorption layer.

More specifically, first, an emulsion containing an ultraviolet absorbent was adjusted to the following composition. A composition made up of ethyl acetate (90 equivalent weights), TAYCAPOWEWR BN2070M manufactured by TAYCA (5 equivalent weights), Tinuvin 400 manufactured by BASF (30 equivalent weights), and DOS manufactured by Daihachi Chemical Industry Co., Ltd. (50 equivalent weights) was emulsified and dispersed in a gelatin aqueous solution made up of gelatin (100 equivalent weights) and water (500 equivalent weights), thereby producing Emulsion A. A composition obtained by mixing and dissolving Emulsion A (30 equivalent weights) into water (90 equivalent weights) was used as a composition for forming the ultraviolet absorption layer. Next, using a bar coater, the thickness of the ultraviolet absorption layer was appropriately adjusted, the amount of the ultraviolet absorbent applied per unit area was adjusted, a desired optical spectrum was obtained, and then a drying treatment was carried out, thereby forming an ultraviolet absorption layer. The drying temperature was 50° C., and the drying time was 10 minutes.

On the ultraviolet absorption layer formed in the above-described order, an optical adhesive (8146-3 manufactured by 3M Company) and cover glass were laminated in this order, thereby producing a touch panel sensor-containing laminate.

Next, the surface of the touch panel sensor on a side opposite to the cover glass surface in the touch panel sensor-containing laminate and the display surface of an image display device were attached together through an ultraviolet-curable adhesive (CEF2806 manufactured by 3M Company), the uniformly-attached state was confirmed, then, the cover glass side was irradiated with ultraviolet rays (including light having wavelengths in a range of longer than 340 nm and 400 nm or shorter) (using a metal halide lamp at an energy amount of 4 J/cm²), and the ultraviolet-curable adhesive was cured, thereby producing Touch Panel 101.

Meanwhile, the ultraviolet-curable adhesive (CEF2806 manufactured by 3M Company) was cured using light having wavelengths in a range of longer than 340 nm and 400 nm or shorter.

(Touch Panels 102 to 136)

Touch panels having transmittances as shown in Table 1 were produced by changing the polymer film in the touch panel sensor, the kind of the ultraviolet absorbent in Emulsion A, the amount of the ultraviolet absorbent applied per unit area, and the like for Touch Panel 101 as shown in Table 1.

As the polymer films in the touch panel sensors shown in Table 1, the following films were respectively used. “ZF14-100”: ZEONOR ZF14-100 manufactured by Zeon Corporation (100 μm-thick cyclic olefin polymer film)

“FEKP040”: ARTON FEKP040 manufactured by JSR Corporation (40 μm-thick cyclic olefin polymer film)

“TDF-050”: TDF-050 manufactured by Dexerials Corporation (50 μm-thick cyclic olefin polymer film)

“ZF14-40”: ZF14-40 manufactured by Zeon Corporation (40 μm-thick cyclic olefin polymer film)

As the ultraviolet absorbents, the following absorbents were used.

“TINUVIN 400”, “TINUVIN 405”, “TINUVIN 479”: hydroxyphenyl triazine-based ultraviolet absorbents (manufactured by BASF)

“TINUVIN PS”, “TINUVIN 384-2”: benzotriazole-based ultraviolet absorbents (manufactured by BASF)

<Variety of Evaluations>

(Drop Impact Durability after Ultraviolet Irradiation)

Irradiation (lamp output: 60 W/m², black panel temperature: 55° C.) was carried out for 200 hours on the touch panel produced above using a light resistance tester (manufactured by Suga Test Instruments Co., Ltd.) and a Xe lamp. After the irradiation test, the touch panel was freely dropped toward the floor from a location of 1.2 m high, thereby causing cracks in the cover glass (in a case in which cracks were not caused in the cover glass in the first trial, the drop test was repeated until cracks were caused.) The touch operation of the touch panel after the drop test was checked, and the touch panel was determined to have favorable drop impact durability (A) in a case in which the touch sensor functioned properly and determined to have poor drop impact durability (B) in a case in which the touch sensor did not function.

(Tone Evaluation and Transmittance Measurement)

The transmittances of the ultraviolet absorption layer at individual wavelengths were obtained by, as described above, measuring the total light transmittances of a sample substrate having the ultraviolet absorption layer formed on a glass substrate and the glass substrate and computing the transmittances from Equation (1). The L* value, a* value, and b* value of transmitted light were computed using the transmittances of the ultraviolet absorption layer and the method prescribed in JIS-Z8729:1994.

In a case in which the value of |b*| which is the absolute value of the b* value was less than 1, the tone was considered as neutral and determined as A. Furthermore, in a case in which the value of was less than |b*|, the tint was more preferable and determined as AA. In a case in which the value of |b*| was 1 or more, the tone was considered to appear yellowish or bluish and determined as B.

“AA”: A case in which was less than 0.5

“A”: A case in which |b*| was 0.5 or more and less than 1

“B”: A case in which |b*| was 1 or more

The transmittances of the ultraviolet absorption layer at individual wavelengths were obtained by, as described above, measuring the total light transmittances of a sample substrate having the ultraviolet absorption layer formed on a glass substrate and the glass substrate and computing the transmittances from Equation (1). The L* value, a* value, and b* value of transmitted light were computed using the transmittances of the ultraviolet absorption layer and the method prescribed in JIS-Z8729:1994.

(Direct Bonding Manufacturing Suitability)

The touch panel sensor-containing laminate, an ultraviolet-curable adhesive (CEF2806 manufactured by 3M Company), and an image display device were laminated in this order, and the touch panel sensor-containing laminate side was irradiated with UV light (4 J/cm²), thereby fixing the touch panel sensor-containing laminate and the image display device. The peeling strength was measured in a case in which the touch panel sensor-containing laminate was peeled off from the image display device (90-degree vertical lifting), and, in a case in which the maximum value of the peeling strength was 5 N/cm or more, it was determined that the adhesive force of the adhesive layer (the adhesive layer formed by curing an ultraviolet-curable adhesive) was strong and the ultraviolet-curable adhesive was sufficiently cured, and the manufacturing suitability was evaluated as A. Furthermore, in a case in which the maximum value of the peeling strength was 7.5 N/cm or more, the manufacturing suitability was evaluated as AA. In a case in which the maximum value of the peeling strength was less than 5 N/cm, the manufacturing suitability was evaluated as B.

“AA”: A case in which the maximum value of the peeling strength was 7.5 N/cm or more

“A”: A case in which the maximum value of the peeling strength was 5 N/cm or more and less than 7.5 N/cm

“B”: A case in which the maximum value of the peeling strength was less than 5 N/cm

In Table 1, “Maximum % of transmittance difference at 400 to 800 nm vs. 400 nm” indicates the absolute value of the maximum transmittance difference between the transmittance in a wavelength range of 400 to 800 nm and the transmittance at a wavelength of 400 nm, in other words, the absolute value of the difference between the maximum value or minimum value of the transmittance in a wavelength range of 400 to 800 nm and the transmittance at a wavelength of 400 nm. In a case in which the above-described numerical value is ±3% or less, the transmittance in a wavelength range of 400 to 800 nm is in a range of ±3% or less of the transmittance at a wavelength of 400 nm.

TABLE 1

| | | Ultraviolet absorption layer | | | | | | | | |
|---|---|---|---|---|---|---|---|---|---|---|
| | | | | | | Maximum % of | Evaluation | | | |
| | Polymer | | Amount | Maximum | | transmit- | | | Direct | |
| | film in | UV | of UV | transmit- | | tance | | | bonding | |
| | touch | absorbent | absorbent | tance | Transmit- | difference at | Drop | | manufac- | |
| | panel | (addition | applied | at 200 to | tance | 400 to 800 nm | impact | | turing | |
| Table 1 | sensor | ratio) | [g/m²] | 340 nm [%] | at 400 nm[%] | vs. 400 nm | resistance | Tone | suitability | Note |
| Example 101 | ZF14-100 | Tinuvin 400 | 0.65 | 4.1 | 96.2 | 1.1% | A | A | AA | Present |
| | | | | | | | | | | Invention |
| Example 102 | ZF14-100 | Tinuvin 479/ | 0.43 | 2.1 | 97.5 | 0.5% | A | AA | AA | Present |
| | | Tinuvin PS | | | | | | | | Invention |
| | | (=1/2) | | | | | | | | |
| Example 103 | ZF14-100 | Tinuvin 405 | 0.62 | 2.2 | 98.4 | 0.3% | A | AA | A | Present |
| | | | | | | | | | | Invention |
| Example 104 | ZF14-100 | Tinuvin PS | 0.45 | 1.3 | 92.6 | 1.1% | A | A | A | Present |
| | | | | | | | | | | Invention |
| Example 105 | ZF14-100 | Tinuvin 384-2 | 0.65 | 2.5 | 88.4 | 4.3% | A | B | A | Comparative |
| | | | | | | | | | | Example |
| Example 106 | ZF14-100 | Tinuvin PS | 0.80 | 0.1 | 84.7 | 0.9% | A | A | B | Comparative |
| | | | | | | | | | | Example |
| Example 107 | ZF14-100 | Tinuvin PS | 0.23 | 6.4 | 99.6 | 0.2% | B | AA | AA | Comparative |
| | | | | | | | | | | Example |
| Example 108 | ZF14-100 | Tinuvin 479 | 0.43 | 13.0 | 98.0 | 0.5% | B | AA | AA | Comparative |
| | | | | | | | | | | Example |
| Example 109 | ZF14-100 | None | 0 | 93.7 | 98.7 | 0.2% | B | AA | AA | Comparative |
| | | | | | | | | | | Example |
| Example 110 | FEKP040 | Tinuvin 400 | 0.65 | 4.1 | 96.0 | 1.1% | A | A | AA | Present |
| | | | | | | | | | | Invention |
| Example 111 | FEKP040 | Tinuvin 479/ | 0.43 | 2.1 | 97.3 | 0.5% | A | AA | AA | Present |
| | | Tinuvin PS | | | | | | | | Invention |
| | | (=1/2) | | | | | | | | |
| Example 112 | FEKP040 | Tinuvin 405 | 0.62 | 2.2 | 98.2 | 0.3% | A | AA | A | Present |
| | | | | | | | | | | Invention |
| Example 113 | FEKP040 | Tinuvin PS | 0.45 | 1.3 | 92.4 | 1.1% | A | A | A | Present |
| | | | | | | | | | | Invention |
| Example 114 | FEKP040 | Tinuvin 384-2 | 0.65 | 2.5 | 88.2 | 4.3% | A | B | A | Comparative |
| | | | | | | | | | | Example |
| Example 115 | FEKP040 | Tinuvin PS | 0.80 | 0.1 | 84.5 | 0.9% | A | A | B | Comparative |
| | | | | | | | | | | Example |
| Example 116 | FEKP040 | Tinuvin PS | 0.23 | 6.4 | 99.3 | 0.2% | B | AA | AA | Comparative |
| | | | | | | | | | | Example |
| Example 117 | FEKP040 | Tinuvin 479 | 0.43 | 13.0 | 97.8 | 0.5% | B | AA | AA | Comparative |
| | | | | | | | | | | Example |
| Example 118 | FEKP040 | None | 0 | 93.5 | 98.4 | 0.2% | B | AA | AA | Comparative |
| | | | | | | | | | | Example |
| Example 119 | TDF-50 | Tinuvin 400 | 0.65 | 4.1 | 95.5 | 1.1% | A | A | AA | Present |
| | | | | | | | | | | Invention |
| Example 120 | TDF-50 | Tinuvin 479/ | 0.43 | 2.1 | 96.8 | 0.5% | A | AA | AA | Present |
| | | Tinuvin PS | | | | | | | | Invention |
| | | (=1/2) | | | | | | | | |
| Example 121 | TDF-50 | Tinuvin 405 | 0.62 | 2.2 | 97.7 | 0.3% | A | AA | A | Present |
| | | | | | | | | | | Invention |
| Example 122 | TDF-50 | Tinuvin PS | 0.45 | 1.3 | 92.0 | 1.1% | A | A | A | Present |
| | | | | | | | | | | Invention |
| Example 123 | TDF-50 | Tinuvin 384-2 | 0.65 | 2.5 | 87.7 | 4.3% | A | B | A | Comparative |
| | | | | | | | | | | Example |
| Example 124 | TDF-50 | Tinuvin PS | 0.80 | 0.1 | 84.0 | 0.9% | A | A | B | Comparative |
| | | | | | | | | | | Example |
| Example 125 | TDF-50 | Tinuvin PS | 0.23 | 6.4 | 98.9 | 0.2% | B | AA | AA | Comparative |
| | | | | | | | | | | Example |
| Example 126 | TDF-50 | Tinuvin 479 | 0.43 | 13.0 | 97.4 | 0.5% | B | AA | AA | Comparative |
| | | | | | | | | | | Example |
| Example 127 | TDF-50 | None | 0 | 94.0 | 98.0 | 0.2% | B | AA | AA | Comparative |
| | | | | | | | | | | Example |
| Example 128 | ZF14-40 | Tinuvin 400 | 0.65 | 4.1 | 96.5 | 1.1% | A | A | AA | Present |
| | | | | | | | | | | Invention |
| Example 129 | ZF14-40 | Tinuvin 479/ | 0.43 | 2.1 | 97.8 | 0.5% | A | AA | AA | Present |
| | | Tinuvin PS | | | | | | | | Invention |
| | | (=1/2) | | | | | | | | |
| Example 130 | ZF14-40 | Tinuvin 405 | 0.62 | 2.2 | 98.7 | 0.3% | A | AA | A | Present |
| | | | | | | | | | | Invention |
| Example 131 | ZF14-40 | Tinuvin PS | 0.45 | 1.3 | 92.9 | 1.1% | A | A | A | Present |
| | | | | | | | | | | Invention |
| Example 132 | ZF14-40 | Tinuvin 384-2 | 0.65 | 2.5 | 88.7 | 4.3% | A | B | A | Comparative |
| | | | | | | | | | | Example |
| Example 133 | ZF14-40 | Tinuvin PS | 0.80 | 0.1 | 85.0 | 0.9% | A | A | B | Comparative |
| | | | | | | | | | | Example |
| Example 134 | ZF14-40 | Tinuvin PS | 0.23 | 6.4 | 99.9 | 0.2% | B | AA | AA | Comparative |
| | | | | | | | | | | Example |
| Example 135 | ZF14-40 | Tinuvin 479 | 0.43 | 13.0 | 98.4 | 0.5% | B | AA | AA | Comparative |
| | | | | | | | | | | Example |
| Example 136 | ZF14-40 | None | 0 | 94.0 | 99.0 | 0.2% | B | AA | AA | Comparative |
| | | | | | | | | | | Example |

As shown in Table 1, in touch panels satisfying predetermined requirements, results of favorable drop impact durability, tones, and direct bonding manufacturing suitability were obtained.

Meanwhile, it was confirmed that, in a case in which the transmittance of the ultraviolet absorption layer in a wavelength range of 400 to 800 nm is in a range of ±0.6% or less of the transmittance at a wavelength of 400 nm, the tones are superior.

### <Example B> (Touch Panel 201)

A touch panel sensor was produced in the same manner as in Example A.

As an optical adhesive layer used in the case of attaching a touch panel sensor and cover glass, an optical adhesive layer containing an ultraviolet absorbent (ultraviolet absorbent-containing optical adhesive layer) was applied, and a touch panel was produced as described below.

A coating fluid was produced by adding Tinuvin 400 manufactured by BASF (0.1 equivalent weights) as an ultraviolet absorbent to a composition made up of KURAPRENE LIR-30 manufactured by Kuraray Co., Ltd. (22 equivalent weights), Polyvest 110 manufactured by EVONIK Japan Co., Ltd. (8 equivalent weights), 2-ethylhexyl acrylate (7.5 equivalent weights), isobornyl acrylate (15.5 equivalent weights), Lucirin TPO manufactured by BASF (3 equivalent weights), CLEARON P135 manufactured by Yasuhara Chemical Co., Ltd. (41 equivalent weights), Irgafos 168 manufactured by BASF (0.5 equivalent weights), 1,9-nonanediol diacrylate (0.5 equivalent weights), and CYCLOMER M100 manufactured by Daicel FineChem Ltd. (2 equivalent weights). The coating fluid was applied onto one surface of a polyethylene terephthalate (PET) film (manufactured by Toray Industries, Inc., thickness: 38 μm) on which a silicone treatment had been carried out, and a PET film on which a silicone treatment had been carried out in the same manner was overlaid from above the applied coating fluid so as to uniformly spread the fluid by pressure, and a film was fixed so that the thickness reached 0.075 mm. This film was irradiated with ultraviolet rays using a metal halide lamp at an energy amount of 7 J/cm², thereby obtaining a 0.075 mm-thick optical adhesive layer.

A touch panel sensor and cover glass were attached together using the optical adhesive layer obtained as described above. After that, the surface of the touch panel sensor on a side opposite to the surface to which the cover glass was attached and an image display device were attached together through an ultraviolet-curable adhesive (CEF2806 manufactured by 3M Company), the uniformly-attached state was confirmed, then, the cover glass side was irradiated with ultraviolet rays (using a metal halide lamp at an energy amount of 4 J/cm²), and the ultraviolet-curable adhesive was cured. In the above-described manner, Touch Panel 201 was produced (refer to FIG. 7).

(Touch Panels 202 to 236)

Touch panels having transmittances as shown in Table 2 were produced by changing the polymer film in the touch panel sensor, the kind and content (amount per unit area) of the ultraviolet absorbent in the optical adhesive layer including the ultraviolet absorbent, and the like for Touch Panel 201 as shown in Table 2.

The evaluations described in the section of Example A were carried out using the obtained touch panels, and the results were summarized in Table 2

TABLE 2

| | | Ultraviolet absorbent-containing optical adhesive layer | | | | | | | | |
|---|---|---|---|---|---|---|---|---|---|---|
| | | | | | | Maximum % of | Evaluation | | | |
| | Polymer | | | Maximum | | transmit- | | | Direct | |
| | film in | UV | Content | transmit- | | tance | | | bonding | |
| | touch | absorbent | of UV | tance | Transmit- | difference at | Drop | | manufac- | |
| | panel | (addition | absorbent | at 200 to | tance | 400 to 800 nm | impact | | turing | |
| Table 2 | sensor | ratio) | [g/m²] | 340 nm [%] | at 400 nm[%] | vs. 400 nm | resistance | Tone | suitability | Note |
| Example 201 | ZF14-100 | Tinuvin400 | 0.65 | 4.2 | 96.4 | 1.0% | A | A | AA | Present |
| | | | | | | | | | | Invention |
| Example 202 | ZF14-100 | Tinuvin479/ | 0.43 | 2.0 | 97.7 | 0.5% | A | AA | AA | Present |
| | | Tinuvin PS | | | | | | | | Invention |
| | | (=1/2) | | | | | | | | |
| Example 203 | ZF14-100 | Tinuvin405 | 0.62 | 2.1 | 98.6 | 0.3% | A | AA | A | Present |
| | | | | | | | | | | Invention |
| Example 204 | ZF14-100 | Tinuvin PS | 0.45 | 1.4 | 92.8 | 1.2% | A | A | A | Present |
| | | | | | | | | | | Invention |
| Example 205 | ZF14-100 | Tinuvin384-2 | 0.65 | 2.6 | 88.5 | 4.6% | A | B | A | Comparative |
| | | | | | | | | | | Example |
| Example 206 | ZF14-100 | Tinuvin PS | 0.80 | 0.2 | 85.1 | 0.8% | A | A | B | Comparative |
| | | | | | | | | | | Example |
| Example 207 | ZF14-100 | Tinuvin PS | 0.23 | 6.2 | 99.7 | 0.2% | B | AA | AA | Comparative |
| | | | | | | | | | | Example |
| Example 208 | ZF14-100 | Tinuvin479 | 0.43 | 12.5 | 98.4 | 0.4% | B | AA | AA | Comparative |
| | | | | | | | | | | Example |
| Example 209 | ZF14-100 | None | 0 | 94.6 | 98.8 | 0.2% | B | AA | AA | Comparative |
| | | | | | | | | | | Example |
| Example 210 | FEKP040 | Tinuvin400 | 0.65 | 4.2 | 96.2 | 1.0% | A | A | AA | Present |
| | | | | | | | | | | Invention |
| Example 211 | FEKP040 | Tinuvin479/ | 0.43 | 2.0 | 97.5 | 0.5% | A | AA | AA | Present |
| | | Tinuvin PS | | | | | | | | Invention |
| | | (=1/2) | | | | | | | | |
| Example 212 | FEKP040 | Tinuvin405 | 0.62 | 2.1 | 98.4 | 0.3% | A | AA | A | Present |
| | | | | | | | | | | Invention |
| Example 213 | FEKP040 | Tinuvin PS | 0.45 | 1.4 | 92.6 | 1.2% | A | A | A | Present |
| | | | | | | | | | | Invention |
| Example 214 | FEKP040 | Tinuvin384-2 | 0.65 | 2.6 | 88.3 | 4.6% | A | B | A | Comparative |
| | | | | | | | | | | Example |
| Example 215 | FEKP040 | Tinuvin PS | 0.80 | 0.2 | 84.9 | 0.8% | A | A | B | Comparative |
| | | | | | | | | | | Example |
| Example 216 | FEKP040 | Tinuvin PS | 0.23 | 6.2 | 99.5 | 0.2% | B | AA | AA | Comparative |
| | | | | | | | | | | Example |
| Example 217 | FEKP040 | Tinuvin479 | 0.43 | 12.5 | 98.2 | 0.4% | B | AA | AA | Comparative |
| | | | | | | | | | | Example |
| Example 218 | FEKP040 | None | 0 | 94.3 | 98.6 | 0.2% | B | AA | AA | Comparative |
| | | | | | | | | | | Example |
| Example 219 | TDF-50 | Tinuvin400 | 0.65 | 4.2 | 95.8 | 1.0% | A | A | AA | Present |
| | | | | | | | | | | Invention |
| Example 220 | TDF-50 | Tinuvin479/ | 0.43 | 2.0 | 97.1 | 0.5% | A | AA | AA | Present |
| | | Tinuvin PS | | | | | | | | Invention |
| | | (=1/2) | | | | | | | | |
| Example 221 | TDF-50 | Tinuvin405 | 0.62 | 2.1 | 97.9 | 0.3% | A | AA | A | Present |
| | | | | | | | | | | Invention |
| Example 222 | TDF-50 | Tinuvin PS | 0.45 | 1.4 | 92.2 | 1.2% | A | A | A | Present |
| | | | | | | | | | | Invention |
| Example 223 | TDF-50 | Tinuvin384-2 | 0.65 | 2.6 | 87.8 | 4.6% | A | B | A | Comparative |
| | | | | | | | | | | Example |
| Example 224 | TDF-50 | Tinuvin PS | 0.80 | 0.2 | 84.5 | 0.8% | A | A | B | Comparative |
| | | | | | | | | | | Example |
| Example 225 | TDF-50 | Tinuvin PS | 0.23 | 6.2 | 99.0 | 0.2% | B | AA | AA | Comparative |
| | | | | | | | | | | Example |
| Example 226 | TDF-50 | Tinuvin479 | 0.43 | 12.5 | 97.7 | 0.4% | B | AA | AA | Comparative |
| | | | | | | | | | | Example |
| Example 227 | TDF-50 | None | 0 | 94.6 | 98.2 | 0.2% | B | AA | AA | Comparative |
| | | | | | | | | | | Example |
| Example 228 | ZF14-40 | Tinuvin400 | 0.65 | 4.2 | 96.6 | 1.0% | A | A | AA | Present |
| | | | | | | | | | | Invention |
| Example 229 | ZF14-40 | Tinuvin479/ | 0.43 | 2.0 | 97.9 | 0.5% | A | AA | AA | Present |
| | | Tinuvin PS | | | | | | | | Invention |
| | | (=1/2) | | | | | | | | |
| Example 230 | ZF14-40 | Tinuvin405 | 0.62 | 2.1 | 98.8 | 0.3% | A | AA | A | Present |
| | | | | | | | | | | Invention |
| Example 231 | ZF14-40 | Tinuvin PS | 0.45 | 1.4 | 93.0 | 1.2% | A | A | A | Present |
| | | | | | | | | | | Invention |
| Example 232 | ZF14-40 | Tinuvin384-2 | 0.65 | 2.6 | 88.7 | 4.6% | A | B | A | Comparative |
| | | | | | | | | | | Example |
| Example 233 | ZF14-40 | Tinuvin PS | 0.80 | 0.2 | 85.3 | 0.8% | A | A | B | Comparative |
| | | | | | | | | | | Example |
| Example 234 | ZF14-40 | Tinuvin PS | 0.23 | 6.2 | 99.9 | 0.2% | B | AA | AA | Comparative |
| | | | | | | | | | | Example |
| Example 235 | ZF14-40 | Tinuvin479 | 0.43 | 12.5 | 98.6 | 0.4% | B | AA | AA | Comparative |
| | | | | | | | | | | Example |
| Example 236 | ZF14-40 | None | 0 | 94.9 | 99.1 | 0.2% | B | AA | AA | Comparative |
| | | | | | | | | | | Example |

As shown in Table 2, in touch panels satisfying predetermined requirements, results of favorable drop impact durability, tones, and direct bonding manufacturing suitability were obtained.

### Example C

(Touch Panel 301)

In the production of an antihalation layer including a dye that was decolored by alkalis in developers in a stage of producing a touch panel sensor, an appropriate amount of Emulsion A including the ultraviolet absorbent, which was produced in Example A, was added, thereby producing an antihalation layer containing the ultraviolet absorbent (corresponding to the ultraviolet absorption layer). The antihalation layer containing the ultraviolet absorbent was installed only on one surface side of a polymer film (this surface will be referred to as A surface), and the other antihalation layer did not include any ultraviolet absorbent (refer to FIGS. 8 and 9).

On the touch panel sensor surface on the A surface side, an optical adhesive (8146-3 manufactured by 3M Company) and cover glass were laminated in this order, thereby producing a touch panel sensor-containing laminate. The surface of the touch panel sensor on a side opposite to the cover glass surface in the touch panel sensor-containing laminate and the display surface of an image display device were attached together through an ultraviolet-curable adhesive (CEF2806 manufactured by 3M Company), the uniformly-attached state was confirmed, then, the cover glass side was irradiated with ultraviolet rays (using a metal halide lamp at an energy amount of 4 J/cm²), and the ultraviolet-curable adhesive was cured. In the above-described manner, Touch Panel 301 was produced.

(Touch panels 301 to 336)

Touch panels having transmittances as shown in Table 3 were produced by changing the polymer film in the touch panel sensor, the kind of the ultraviolet absorbent in Emulsion A, the amount of the ultraviolet absorbent applied per unit area, and the like for Touch Panel 301 as shown in Table 3.

The evaluations described in the section of Example A were carried out using the obtained touch panels, and the results were summarized in Table 3.

TABLE 3

| | | Ultraviolet absorption layer | | | | | | | | |
|---|---|---|---|---|---|---|---|---|---|---|
| | | | | | | Maximum % of | Evaluation | | | |
| | Polymer | | Amount | Maximum | | transmit- | | | Direct | |
| | film in | UV | of UV | transmit- | | tance | | | bonding | |
| | touch | absorbent | absorbent | tance | Transmit- | difference at | Drop | | manufac- | |
| | panel | (addition | applied | at 200 to | tance | 400 to 800 nm | impact | | turing | |
| Table 3 | sensor | ratio) | [g/m²] | 340 nm [%] | at 400 nm [%] | vs. 400 nm | resistance | Tone | suitability | Note |
| Example 301 | ZF14-100 | Tinuvin 400 | 0.65 | 4.6 | 96.5 | 1.0% | A | A | AA | Present |
| | | | | | | | | | | Invention |
| Example 302 | ZF14-100 | Tinuvin 479/ | 0.43 | 2.1 | 97.8 | 0.5% | A | AA | AA | Present |
| | | Tinuvin PS | | | | | | | | Invention |
| | | (=1/2) | | | | | | | | |
| Example 303 | ZF14-100 | Tinuvin 405 | 0.62 | 2.0 | 98.6 | 0.2% | A | AA | A | Present |
| | | | | | | | | | | Invention |
| Example 304 | ZF14-100 | Tinuvin PS | 0.45 | 1.6 | 92.9 | 1.1% | A | A | A | Present |
| | | | | | | | | | | Invention |
| Example 305 | ZF14-100 | Tinuvin 384-2 | 0.65 | 2.4 | 88.7 | 3.8% | A | B | A | Comparative |
| | | | | | | | | | | Example |
| Example 306 | ZF14-100 | Tinuvin PS | 0.80 | 0.1 | 85.1 | 1.0% | A | A | B | Comparative |
| | | | | | | | | | | Example |
| Example 307 | ZF14-100 | Tinuvin PS | 0.23 | 6.0 | 99.8 | 0.3% | B | AA | AA | Comparative |
| | | | | | | | | | | Example |
| Example 308 | ZF14-100 | Tinuvin 479 | 0.43 | 12.2 | 98.5 | 0.4% | B | AA | AA | Comparative |
| | | | | | | | | | | Example |
| Example 309 | ZF14-100 | None | 0 | 93.5 | 98.9 | 0.2% | B | AA | AA | Comparative |
| | | | | | | | | | | Example |
| Example 310 | FEKP040 | Tinuvin 400 | 0.65 | 4.5 | 96.3 | 1.0% | A | A | AA | Present |
| | | | | | | | | | | Invention |
| Example 311 | FEKP040 | Tinuvin 479/ | 0.43 | 2.0 | 97.6 | 0.5% | A | AA | AA | Present |
| | | Tinuvin PS | | | | | | | | Invention |
| | | (=1/2) | | | | | | | | |
| Example 312 | FEKP040 | Tinuvin 405 | 0.62 | 2.1 | 98.4 | 0.2% | A | AA | A | Present |
| | | | | | | | | | | Invention |
| Example 313 | FEKP040 | Tinuvin PS | 0.45 | 1.4 | 92.7 | 1.1% | A | A | A | Present |
| | | | | | | | | | | Invention |
| Example 314 | FEKP040 | Tinuvin 384-2 | 0.65 | 2.6 | 88.5 | 3.8% | A | B | A | Comparative |
| | | | | | | | | | | Example |
| Example 315 | FEKP040 | Tinuvin PS | 0.80 | 0.2 | 84.9 | 1.0% | A | A | B | Comparative |
| | | | | | | | | | | Example |
| Example 316 | FEKP040 | Tinuvin PS | 0.23 | 6.2 | 99.6 | 0.3% | B | AA | AA | Comparative |
| | | | | | | | | | | Example |
| Example 317 | FEKP040 | Tinuvin 479 | 0.43 | 12.5 | 98.3 | 0.4% | B | AA | AA | Comparative |
| | | | | | | | | | | Example |
| Example 318 | FEKP040 | None | 0 | 93.6 | 98.7 | 0.2% | B | AA | AA | Comparative |
| | | | | | | | | | | Example |
| Example 319 | TDF-50 | Tinuvin 400 | 0.65 | 4.2 | 96.0 | 1.0% | A | A | AA | Present |
| | | | | | | | | | | Invention |
| Example 320 | TDF-50 | Tinuvin 479/ | 0.43 | 2.0 | 97.3 | 0.5% | A | AA | AA | Present |
| | | Tinuvin PS | | | | | | | | Invention |
| | | (=1/2) | | | | | | | | |
| Example 321 | TDF-50 | Tinuvin 405 | 0.62 | 2.1 | 98.0 | 0.2% | A | AA | A | Present |
| | | | | | | | | | | Invention |
| Example 322 | TDF-50 | Tinuvin PS | 0.45 | 1.4 | 92.4 | 1.1% | A | A | A | Present |
| | | | | | | | | | | Invention |
| Example 323 | TDF-50 | Tinuvin 384-2 | 0.65 | 2.6 | 88.2 | 3.8% | A | B | A | Comparative |
| | | | | | | | | | | Example |
| Example 324 | TDF-50 | Tinuvin PS | 0.80 | 0.2 | 84.6 | 1.0% | A | A | B | Comparative |
| | | | | | | | | | | Example |
| Example 325 | TDF-50 | Tinuvin PS | 0.23 | 6.2 | 99.2 | 0.3% | B | AA | AA | Comparative |
| | | | | | | | | | | Example |
| Example 326 | TDF-50 | Tinuvin 479 | 0.43 | 12.5 | 97.9 | 0.4% | B | AA | AA | Comparative |
| | | | | | | | | | | Example |
| Example 327 | TDF-50 | None | 0 | 93.3 | 97.6 | 0.2% | B | AA | AA | Comparative |
| | | | | | | | | | | Example |
| Example 328 | ZF14-40 | Tinuvin 400 | 0.65 | 4.2 | 96.8 | 1.0% | A | A | AA | Present |
| | | | | | | | | | | Invention |
| Example 329 | ZF14-40 | Tinuvin 479/ | 0.43 | 2.0 | 98.2 | 0.5% | A | AA | AA | Present |
| | | Tinuvin PS | | | | | | | | Invention |
| | | (=1/2) | | | | | | | | |
| Example 330 | ZF14-40 | Tinuvin 405 | 0.62 | 2.1 | 98.9 | 0.2% | A | AA | A | Present |
| | | | | | | | | | | Invention |
| Example 331 | ZF14-40 | Tinuvin PS | 0.45 | 1.4 | 93.3 | 1.1% | A | A | A | Present |
| | | | | | | | | | | Invention |
| Example 332 | ZF14-40 | Tinuvin 384-2 | 0.65 | 2.6 | 89.0 | 3.8% | A | B | A | Comparative |
| | | | | | | | | | | Example |
| Example 333 | ZF14-40 | Tinuvin PS | 0.80 | 0.2 | 85.4 | 1.0% | A | A | B | Comparative |
| | | | | | | | | | | Example |
| Example 334 | ZF14-40 | Tinuvin PS | 0.23 | 6.2 | 99.8 | 0.3% | B | AA | AA | Comparative |
| | | | | | | | | | | Example |
| Example 335 | ZF14-40 | Tinuvin 479 | 0.43 | 12.5 | 98.8 | 0.4% | B | AA | AA | Comparative |
| | | | | | | | | | | Example |
| Example 336 | ZF14-40 | None | 0 | 94.5 | 99.1 | 0.2% | B | AA | AA | Comparative |
| | | | | | | | | | | Example |

As shown in Table 3, in touch panels satisfying the predetermined requirements, results of favorable drop impact durability, tones, and direct bonding manufacturing suitability were obtained.

### EXPLANATION OF REFERENCES

100, 200, 300: touch panel
2: image display device
4: adhesive layer formed by curing ultraviolet-curable adhesive
6, 16, 260, 360: electrostatic capacitance-type touch panel sensor
8: ultraviolet absorption layer
10: upper adhesive layer
12: protective substrate
14: ultraviolet absorbent-containing adhesive layer
22: polymer film
24: first detection electrode
26: first lead wire
28: second detection electrode
30: second lead wire
32: flexible printed circuit board
34: thin conductive line
36: lattice
38: first polymer film
40: adhesive layer
42: second polymer film

What is claimed is:

1. A touch panel comprising:
an image display device;
an adhesive layer formed by curing an ultraviolet-curable adhesive;
a touch panel sensor; and
a protective substrate in this order,
wherein the touch panel sensor includes any one polymer film of a cyclic olefin polymer film and a cyclic olefin copolymer film,
an ultraviolet absorption layer is provided between the polymer film and the protective substrate,
a transmittance of the ultraviolet absorption layer in a wavelength range of 200 to 340 nm is 5% or less,
a transmittance of the ultraviolet absorption layer at a wavelength of 400 nm is 86% or more,
a transmittance of the ultraviolet absorption layer in a wavelength range of 400 to 800 nm is in a range of ±3% or less of the transmittance at a wavelength of 400 nm, and
the ultraviolet-curable adhesive is cured by light having a wavelength in a range of longer than 340 nm and 400 nm or shorter.

2. The touch panel according to claim 1,
wherein the transmittance of the ultraviolet absorption layer in a wavelength range of 400 to 800 nm is in a range of ±1.5% or less of the transmittance at the wavelength of 400 nm.

3. The touch panel according to claim 1,
wherein the ultraviolet absorption layer is an adhesive layer having an ultraviolet absorbent.

4. The touch panel according to claim 1,
wherein the ultraviolet absorption layer is a non-adhesive layer having an ultraviolet absorbent.

5. The touch panel according to claim 1,
wherein a thickness of the polymer film is 100 μm or less.

6. The touch panel according to claim 1,
wherein the ultraviolet absorbent includes at least one absorbent selected from the group consisting of benzotriazole-based ultraviolet absorbents and hydroxyphenyl triazine-based ultraviolet absorbents.

7. The touch panel according to claim 2,
wherein the ultraviolet absorbent includes at least one absorbent selected from the group consisting of benzotriazole-based ultraviolet absorbents and hydroxyphenyl triazine-based ultraviolet absorbents.

8. The touch panel according to claim 3,
wherein the ultraviolet absorbent includes at least one absorbent selected from the group consisting of benzotriazole-based ultraviolet absorbents and hydroxyphenyl triazine-based ultraviolet absorbents.

9. The touch panel according to claim 4,
wherein the ultraviolet absorbent includes at least one absorbent selected from the group consisting of benzotriazole-based ultraviolet absorbents and hydroxyphenyl triazine-based ultraviolet absorbents.

10. The touch panel according to claim 5,
wherein the ultraviolet absorbent includes at least one absorbent selected from the group consisting of benzotriazole-based ultraviolet absorbents and hydroxyphenyl triazine-based ultraviolet absorbents.
